(19) United States
(12) Patent Application Publication
(10) Pub. No.: US 2026/0075592 A1
(43) Pub. Date: Mar. 12, 2026

(54) PHASE DISCONTINUITY MANAGEMENT WITH RESOURCE ELEMENT (RE) REPETITION

(71) Applicant: QUALCOMM Incorporated, San Diego, CA (US)

(72) Inventors: Chih-Hao LIU, San Diego, CA (US); Jing SUN, San Diego, CA (US); Jing JIANG, San Diego, CA (US)

(21) Appl. No.: 18/827,090

(22) Filed: Sep. 6, 2024

(51) Int. Cl. H04W 72/0446; H04W 72/0453

(52) U.S. Cl. CPC H04W 72/0446; H04W 72/0453

(57) ABSTRACT

Methods, systems, and devices for wireless communications are described. In some systems, a first wireless communication device (e.g., a user equipment (UE) or network entity) may adjust a phase for transmission between a first data transmission and a second data transmission. The phase adjustment may cause phase discontinuity between slots. To support phase estimation at a second wireless communication device, the first wireless communication device may repeat a data symbol modulation signal from the first data transmission in the second data transmission. For example, the data symbol modulation signal may be transmitted via a first resource element (RE) corresponding to a frequency resource of the first data transmission, and the repetition may puncture a second RE corresponding to the same frequency resource of the second data transmission. The second wireless communication device may perform phase estimation using the repetition of the data symbol modulation signal.

### FIELD OF TECHNOLOGY

The following relates to wireless communications, including phase discontinuity management with resource element (RE) repetition.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support demodulation reference signal (DMRS) combining across slots for channel estimation. However, to combine DMRSs from different slots, a wireless communication device may combine DMRSs transmitted using a same phase. If phase continuity is not maintained between slots, the slots may fail to support cross-slot DMRS combining.

### SUMMARY

The systems, methods, and devices of this disclosure each have several innovative aspects, no single one of which is solely responsible for the desirable attributes disclosed herein.

An apparatus for wireless communications is described. The apparatus may include one or more memories storing processor-executable code, and one or more processors coupled with the one or more memories. The one or more processors may individually or collectively be operable to execute the code to cause the apparatus to transmit, via a first slot, a first data signal, a portion of the first data signal including a data symbol modulation signal transmitted via a first resource element (RE) corresponding to a first frequency resource, and transmit, via a second slot subsequent to the first slot, a repetition of the data symbol modulation signal via a second RE corresponding to the first frequency resource, where the transmitting the repetition of the data symbol modulation signal is based on the first slot and the second slot having phase discontinuity. The one or more processors may individually or collectively be further operable to execute the code to cause the apparatus to communicate signaling in accordance with the phase discontinuity based on the repetition of the data symbol modulation signal.

A method for wireless communications is described. The method may include transmitting, via a first slot, a first data signal, a portion of the first data signal including a data symbol modulation signal transmitted via a first RE corresponding to a first frequency resource, and transmitting, via a second slot subsequent to the first slot, a repetition of the data symbol modulation signal via a second RE corresponding to the first frequency resource, where the transmitting the repetition of the data symbol modulation signal is based on the first slot and the second slot having phase discontinuity. The method may further include communicating signaling in accordance with the phase discontinuity based on the repetition of the data symbol modulation signal.

Another apparatus for wireless communications is described. The apparatus may include means for transmitting, via a first slot, a first data signal, a portion of the first data signal including a data symbol modulation signal transmitted via a first RE corresponding to a first frequency resource, and means for transmitting, via a second slot subsequent to the first slot, a repetition of the data symbol modulation signal via a second RE corresponding to the first frequency resource, where the transmitting the repetition of the data symbol modulation signal is based on the first slot and the second slot having phase discontinuity. The apparatus may further include means for communicating signaling in accordance with the phase discontinuity based on the repetition of the data symbol modulation signal.

A non-transitory computer-readable medium storing code for wireless communications is described. The code may include instructions executable by one or more processors to transmit, via a first slot, a first data signal, a portion of the first data signal including a data symbol modulation signal transmitted via a first RE corresponding to a first frequency resource, and transmit, via a second slot subsequent to the first slot, a repetition of the data symbol modulation signal via a second RE corresponding to the first frequency resource, where the transmitting the repetition of the data symbol modulation signal is based on the first slot and the second slot having phase discontinuity. The code may include instructions further executable by the one or more processors to communicate signaling in accordance with the phase discontinuity based on the repetition of the data symbol modulation signal.

Some examples of the method, apparatuses, and non-transitory computer-readable medium described herein may further include operations, features, means, or instructions for communicating a radio resource control (RRC) message indicating an RE repetition frequency domain pattern, where the transmitting the repetition of the data symbol modulation signal may be in accordance with the RE repetition frequency domain pattern.

Some examples of the method, apparatuses, and non-transitory computer-readable medium described herein may further include operations, features, means, or instructions for transmitting a control information message dynamically indicating the repetition of the data symbol modulation signal based on the first slot and the second slot having the phase discontinuity. Some other examples of the method, apparatuses, and non-transitory computer-readable medium described herein may further include operations, features, means, or instructions for transmitting one or more control information messages dynamically indicating the repetition of the data symbol modulation signal and a time domain resource of the second resource element based on the first slot and the second slot having the phase discontinuity.

In some examples of the method, apparatuses, and non-transitory computer-readable medium described herein, the data symbol modulation signal and the repetition of the data symbol modulation signal may be transmitted using a same precoder.

Some examples of the method, apparatuses, and non-transitory computer-readable medium described herein may further include operations, features, means, or instructions for puncturing a second portion of a second data signal associated with the second slot, where transmitting the repetition of the data symbol modulation signal includes transmitting, via the second slot, the second data signal, the second portion of the second data signal including the repetition of the data symbol modulation signal transmitted via the second RE corresponding to the first frequency resource based on the puncturing.

In some examples of the method, apparatuses, and non-transitory computer-readable medium described herein, the first RE corresponds to a last symbol of the first data signal transmitted via the first slot preceding a phase discontinuity gap associated with the first slot and the second slot having the phase discontinuity. In some such examples of the method, apparatuses, and non-transitory computer-readable medium described herein, the second RE corresponds to a first symbol of the second data signal transmitted via the second slot subsequent to the phase discontinuity gap.

In some examples of the method, apparatuses, and non-transitory computer-readable medium described herein, the data symbol modulation signal and the repetition of the data symbol modulation signal may be transmitted using a first precoder associated with the first data signal, and an unpunctured portion of the second data signal may be transmitted using a second precoder associated with the second data signal and different from the first precoder.

In some examples of the method, apparatuses, and non-transitory computer-readable medium described herein, transmitting the repetition of the data symbol modulation signal may include operations, features, means, or instructions for transmitting, via the second slot, a set of multiple repetitions of respective data symbol modulation signals in accordance with an RE repetition frequency domain pattern indicating a repetition density of REs per set of resource blocks (RBs), the first data signal including the respective data symbol modulation signals.

In some examples of the method, apparatuses, and non-transitory computer-readable medium described herein, the repetition of the data symbol modulation signal includes a first repetition of a first data symbol modulation signal corresponding to a first set of coherent demodulation reference signal (DMRS) ports. Some examples of the method, apparatuses, and non-transitory computer-readable medium described herein may further include operations, features, means, or instructions for transmitting, via the second slot, a second repetition of a second data symbol modulation signal corresponding to a second set of coherent DMRS ports, a second portion of the first data signal including the second data symbol modulation signal, where the communicating the signaling may be in accordance with a first phase discontinuity based on the first repetition of the first data symbol modulation signal and a second phase discontinuity based on the second repetition of the second data symbol modulation signal.

In some examples of the method, apparatuses, and non-transitory computer-readable medium described herein, transmitting the first data signal may include operations, features, means, or instructions for rate matching the portion of the first data signal including the first data symbol modulation signal according to a first spatial layer associated with the first set of coherent DMRS ports and rate matching the second portion of the first data signal including the second data symbol modulation signal according to a second spatial layer associated with the second set of coherent DMRS ports.

In some examples of the method, apparatuses, and non-transitory computer-readable medium described herein, transmitting the first repetition of the first data symbol modulation signal and transmitting the second repetition of the second data symbol modulation signal may include operations, features, means, or instructions for transmitting, via the second slot, a first set of multiple repetitions of respective first data symbol modulation signals corresponding to the first set of coherent DMRS ports and a second set of multiple repetitions of respective second data symbol modulation signals corresponding to the second set of coherent DMRS ports, where the transmitting the first set of multiple repetitions and the second set of multiple repetitions may be in accordance with an RE repetition frequency domain pattern indicating a repetition density of REs per set of RBs for both the first set of multiple repetitions and the second set of multiple repetitions, and the first data signal includes the respective first data symbol modulation signals and the respective second data symbol modulation signals.

Some examples of the method, apparatuses, and non-transitory computer-readable medium described herein may further include operations, features, means, or instructions for determining, concurrent to the transmitting the first data signal via the first slot, to change a phase between the first slot and the second slot, where the transmitting the repetition of the data symbol modulation signal may be further based on the determining.

In some examples of the method, apparatuses, and non-transitory computer-readable medium described herein, the data symbol modulation signal includes a quadrature amplitude modulation (QAM) signal or a quadrature phase shift keying (QPSK) modulation signal.

Another apparatus for wireless communications is described. The apparatus may include one or more memories storing processor-executable code, and one or more processors coupled with the one or more memories. The one or more processors may individually or collectively be operable to execute the code to cause the apparatus to receive, via a first slot, a first data signal, a portion of the first data signal including a data symbol modulation signal received via a first RE corresponding to a first frequency resource, and receive, via a second slot subsequent to the first slot, a repetition of the data symbol modulation signal via a second RE corresponding to the first frequency resource, where the receiving the repetition of the data symbol modulation signal is based on the first slot and the second slot having phase discontinuity. The one or more processors may individually or collectively be further operable to execute the code to cause the apparatus to communicate signaling in accordance with a phase estimation of the phase discontinuity based on the repetition of the data symbol modulation signal.

Another method for wireless communications is described. The method may include receiving, via a first slot, a first data signal, a portion of the first data signal including a data symbol modulation signal received via a first RE corresponding to a first frequency resource, and receiving, via a second slot subsequent to the first slot, a repetition of the data symbol modulation signal via a second RE corresponding to the first frequency resource, where the receiving the repetition of the data symbol modulation signal is based on the first slot and the second slot having phase discontinuity. The method may further include communicating signaling in accordance with a phase estimation of the phase discontinuity based on the repetition of the data symbol modulation signal.

Another apparatus for wireless communications is described. The apparatus may include means for receiving, via a first slot, a first data signal, a portion of the first data signal including a data symbol modulation signal received via a first RE corresponding to a first frequency resource, and means for receiving, via a second slot subsequent to the first slot, a repetition of the data symbol modulation signal via a second RE corresponding to the first frequency resource, where the receiving the repetition of the data symbol modulation signal is based on the first slot and the second slot having phase discontinuity. The apparatus may further include means for communicating signaling in accordance with a phase estimation of the phase discontinuity based on the repetition of the data symbol modulation signal.

A non-transitory computer-readable medium storing code for wireless communications is described. The code may include instructions executable by one or more processors to receive, via a first slot, a first data signal, a portion of the first data signal including a data symbol modulation signal received via a first RE corresponding to a first frequency resource, and receive, via a second slot subsequent to the first slot, a repetition of the data symbol modulation signal via a second RE corresponding to the first frequency resource, where the receiving the repetition of the data symbol modulation signal is based on the first slot and the second slot having phase discontinuity. The code may include instructions further executable by the one or more processors to communicate signaling in accordance with a phase estimation of the phase discontinuity based on the repetition of the data symbol modulation signal.

Some examples of the method, apparatuses, and non-transitory computer-readable medium described herein may further include operations, features, means, or instructions for comparing the data symbol modulation signal received via the first RE and the repetition of the data symbol modulation signal received via the second RE to obtain the phase estimation.

Some examples of the method, apparatuses, and non-transitory computer-readable medium described herein may further include operations, features, means, or instructions for communicating an RRC message indicating an RE repetition frequency domain pattern, where the receiving the repetition of the data symbol modulation signal may be in accordance with the RE repetition frequency domain pattern.

Some examples of the method, apparatuses, and non-transitory computer-readable medium described herein may further include operations, features, means, or instructions for receiving a control information message dynamically indicating the repetition of the data symbol modulation signal based on the first slot and the second slot having the phase discontinuity. Some other examples of the method, apparatuses, and non-transitory computer-readable medium described herein may further include operations, features, means, or instructions for receiving one or more control information messages dynamically indicating the repetition of the data symbol modulation signal and a time domain resource of the second resource element based on the first slot and the second slot having the phase discontinuity.

In some examples of the method, apparatuses, and non-transitory computer-readable medium described herein, receiving the repetition of the data symbol modulation signal may include operations, features, means, or instructions for receiving, via the second slot, a second data signal, a second portion of the second data signal punctured with the repetition of the data symbol modulation signal.

In some examples of the method, apparatuses, and non-transitory computer-readable medium described herein, the first RE corresponds to a last symbol of the first data signal received via the first slot preceding a phase discontinuity gap associated with the phase discontinuity, and the second RE corresponds to a first symbol of the second data signal received via the second slot subsequent to the phase discontinuity gap.

In some examples of the method, apparatuses, and non-transitory computer-readable medium described herein, receiving the repetition of the data symbol modulation signal may include operations, features, means, or instructions for receiving, via the second slot, a set of multiple repetitions of respective data symbol modulation signals in accordance with an RE repetition frequency domain pattern indicating a repetition density of REs per set of RBs, the first data signal including the respective data symbol modulation signals.

In some examples of the method, apparatuses, and non-transitory computer-readable medium described herein, the repetition of the data symbol modulation signal includes a first repetition of a first data symbol modulation signal corresponding to a first set of coherent DMRS ports. Some examples of the method, apparatuses, and non-transitory computer-readable medium described herein may further include operations, features, means, or instructions for receiving, via the second slot, a second repetition of a second data symbol modulation signal corresponding to a second set of coherent DMRS ports, a second portion of the first data signal including the second data symbol modulation signal, where the communicating the signaling may be in accordance with a first phase estimation of a first phase discontinuity based on the first repetition of the first data symbol modulation signal and a second phase estimation of a second phase discontinuity based on the second repetition of the second data symbol modulation signal.

In some examples of the method, apparatuses, and non-transitory computer-readable medium described herein, receiving the first repetition of the first data symbol modulation signal and receiving the second repetition of the second data symbol modulation signal may include operations, features, means, or instructions for receiving, via the second slot, a first set of multiple repetitions of respective first data symbol modulation signals corresponding to the first set of coherent DMRS ports and a second set of multiple repetitions of respective second data symbol modulation signals corresponding to the second set of coherent DMRS ports, where the receiving the first set of multiple repetitions and the second set of multiple repetitions may be in accordance with an RE repetition frequency domain pattern indicating a repetition density of REs per set of RBs for both the first set of multiple repetitions and the second set of multiple repetitions, and the first data signal includes the respective first data symbol modulation signals and the respective second data symbol modulation signals.

In some examples of the method, apparatuses, and non-transitory computer-readable medium described herein, the data symbol modulation signal includes a QAM signal or a QPSK modulation signal.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports phase discontinuity management with resource element (RE) repetition in accordance with one or more aspects of the present disclosure.

FIG. 2 shows an example of a network architecture that supports phase discontinuity management with RE repetition in accordance with one or more aspects of the present disclosure.

FIG. 3 shows an example of a wireless communications system that supports phase discontinuity management with RE repetition in accordance with one or more aspects of the present disclosure.

FIGS. 4A and 4B show examples of resource allocations that support phase discontinuity management with RE repetition in accordance with one or more aspects of the present disclosure.

FIG. 5 shows an example of a process flow that supports phase discontinuity management with RE repetition in accordance with one or more aspects of the present disclosure.

FIGS. 6 and 7 show block diagrams of devices that support phase discontinuity management with RE repetition in accordance with one or more aspects of the present disclosure.

FIG. 8 shows a block diagram of a communications manager that supports phase discontinuity management with RE repetition in accordance with one or more aspects of the present disclosure.

FIG. 9 shows a diagram of a system including a UE that supports phase discontinuity management with RE repetition in accordance with one or more aspects of the present disclosure.

FIG. 10 shows a diagram of a system including a network entity that supports phase discontinuity management with RE repetition in accordance with one or more aspects of the present disclosure.

FIGS. 11 through 14 show flowcharts illustrating methods that support phase discontinuity management with RE repetition in accordance with one or more aspects of the present disclosure.

### DETAILED DESCRIPTION

In some wireless communications systems, wireless communication devices may use demodulation reference signals (DMRSs) to support channel estimation for reliable data signal reception. For example, a network entity may transmit one or more DMRSs with a downlink data signal to support physical downlink shared channel (PDSCH) channel estimation at a user equipment (UE). Similarly, a UE may transmit one or more DMRSs with an uplink data signal to support physical uplink shared channel (PUSCH) channel estimation at a network entity. Some systems may support cross-slot DMRS combining to improve channel estimation accuracy, DMRS overhead, or both. For example, a wireless communication device (e.g., a UE or network entity) may use a combination of DMRSs received via multiple slots to perform channel estimation for a current slot. However, if such slots fail to maintain phase continuity (e.g., across a phase discontinuity gap), the slots may fail to support cross-slot DMRS combining. For example, a wireless communication device may fail to support accurate channel estimation using one or more DMRSs transmitted using an unknown updated phase.

To support phase estimation after a phase discontinuity gap—and, correspondingly, support cross-slot DMRS combining across the phase discontinuity gap—a first wireless communication device may repeat one or more data symbol modulation signals from before the phase discontinuity gap via one or more resource elements (REs) after the phase discontinuity gap. A second wireless communication device may receive the same data symbol modulation signal via a first RE prior to the phase discontinuity gap and via a second RE after the phase discontinuity gap. The second wireless communication device may compare the phases of the data symbol modulation signal received before the phase discontinuity gap and the repetition of the data symbol modulation signal received after the phase discontinuity gap to determine the change in phase across the phase discontinuity gap. The second wireless communication device may use this phase estimation to adjust for the change in phase for the DMRSs received via the previous slot to support cross-slot DMRS combining despite the phase discontinuity. Accordingly, the RE repetition may mitigate the phase discontinuity between the slots.

In some examples, the first wireless communication device may include noncoherent DMRS ports. For example, the first wireless communication device may include a first set of DMRS ports (e.g., one or more coherent DMRS ports) noncoherent with a second set of DMRS ports (e.g., on or more second coherent DMRS ports). The first wireless communication device may change the phase independently for the first set of DMRS ports and the second set of DMRS ports. To support phase estimation for noncoherent sets of DMRS ports, the first wireless communication device may perform RE repetition separately for the noncoherent sets of DMRS ports.

Additionally, or alternatively, the first wireless communication device may dynamically indicate the RE repetition across the phase discontinuity gap. In some examples, a network entity may semi-statically configure an RE repetition frequency domain pattern via radio resource control (RRC) signaling. Additionally, or alternatively, potential phase discontinuity gaps (e.g., physical gaps, logical gaps, or both) may be configured for the wireless communication devices. For configured potential phase discontinuity gaps, the first wireless communication device may dynamically signal via control information, such as downlink control information (DCI) or uplink control information (UCI), if an RE repetition is performed. For dynamically determined phase discontinuity gaps, the first wireless communication device may dynamically indicate via DCI or UCI when a phase discontinuity gap occurs (e.g., indicating a time resource of the phase discontinuity gap).

Supporting phase estimation across a phase discontinuity gap using repeated REs may allow the second wireless communication device to perform cross-slot DMRS combining across the phase discontinuity gap. In some examples, the cross-slot DMRS combining may improve a channel estimation accuracy and signaling performance at the second wireless communication device. Additionally, or alternatively, the first wireless communication device may reduce a DMRS density and improve a channel overhead and processing overhead associated with DMRS transmission based on the cross-slot DMRS combining. For example, the first wireless communication device may reduce the DMRS density while maintaining—or mitigating losses to—a DMRS performance based on the improved performance of the cross-slot DMRS combining.

Aspects of the disclosure are initially described in the context of wireless communications systems. Additional aspects of the disclosure are described with reference to resource allocations and process flows. Aspects of the disclosure are further illustrated by and described with reference to apparatus diagrams, system diagrams, and flowcharts that relate to phase discontinuity management with RE repetition.

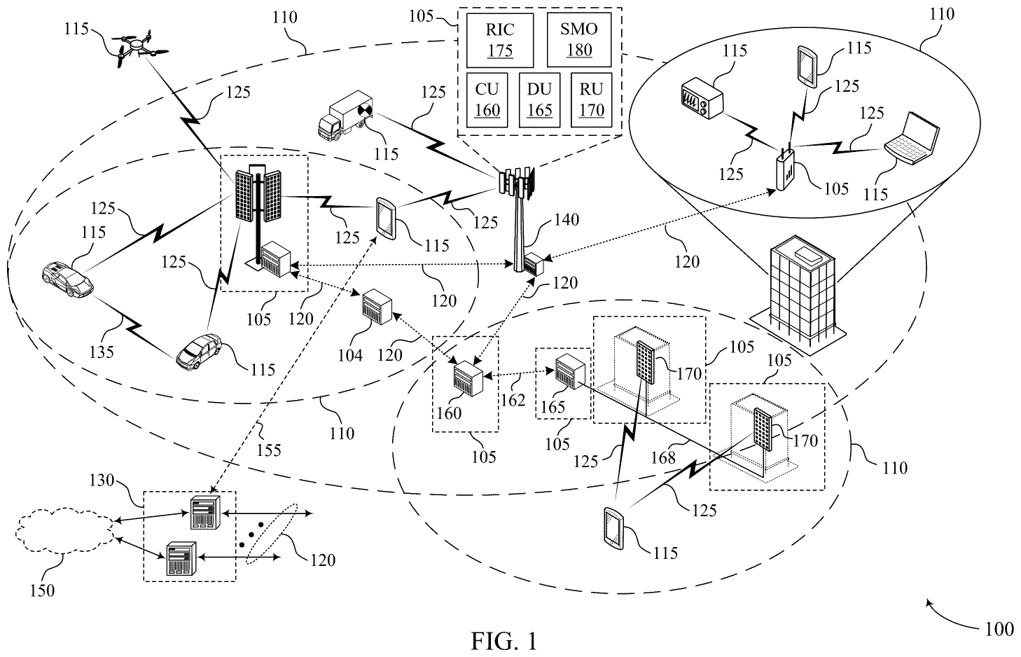

FIG. 1 shows an example of a wireless communications system 100 that supports phase discontinuity management with RE repetition in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, an RE may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods.

The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems 100, wireless devices may use DMRSs to support channel estimation for reliable data signal reception. For example, a network entity 105 may transmit one or more DMRSs with a downlink data signal to support PDSCH channel estimation at a UE 115. Similarly, a UE 115 may transmit one or more DMRSs with an uplink data signal to support PUSCH channel estimation at a network entity 105. Some systems may support cross-slot DMRS combining to improve channel estimation accuracy, DMRS overhead, or both. Cross-slot DMRS combining may involve combining DMRSs measured for different slots at a single device (e.g., intra-UE cross-slot combining) or may involve combining DMRSs measured for different slots by different devices (e.g., inter-UE cross-slot combining). However, if the different slots fail to maintain phase continuity, cross-slot DMRS combining may not be supported for DMRSs transmitted using different phases.

To support phase estimation after a phase discontinuity gap—and, correspondingly, support cross-slot DMRS combining across the phase discontinuity gap—a first wireless communication device may repeat one or more data symbol modulation signals from before the phase discontinuity gap via one or more REs after the phase discontinuity gap. A second wireless communication device may receive the same data symbol modulation signal via a first RE prior to the phase discontinuity gap and via a second RE after the phase discontinuity gap. The second wireless communication device may compare the phases of the data symbol modulation signal and the repetition of the data symbol modulation signal to determine the change in phase across the phase discontinuity gap. The second wireless communication device may use this phase estimation to adjust for the change in phase for the DMRSs received via the previous slot to support cross-slot DMRS combining despite the phase discontinuity. In some examples, the first wireless communication device may be a network entity 105 and the second wireless communication device may be a UE 115. In some other examples, the first wireless communication device may be a UE 115 and the second wireless communication device may be a network entity 105. In yet some other examples, the first and second wireless communication devices may both be UEs 115 or may both be network entities 105.

In some examples, the wireless communication devices may use the RE repetition across the phase discontinuity gap in addition to, or alternative to, gap gluing reference signals (gRSs). A gRS may be a reference signal transmitted relatively close to a phase discontinuity gap to support a device receiving the gRS to estimate the change in phase at the phase discontinuity gap. However, using the RE repetition to support phase estimation may improve a reference signal overhead and resource flexibility as compared to using gRSs.

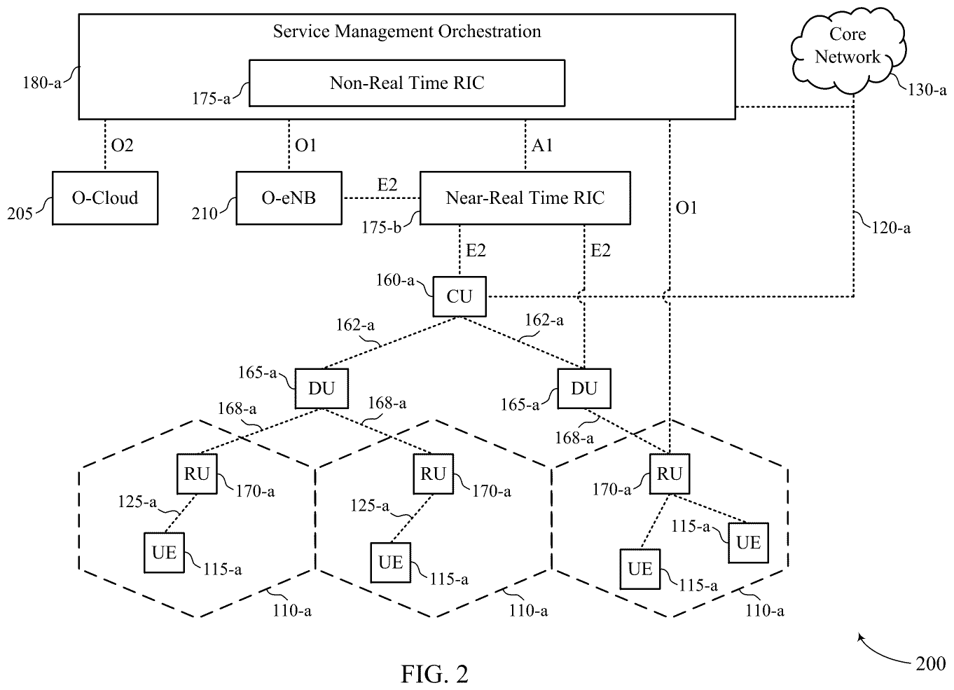

FIG. 2 shows an example of a network architecture 200 that supports phase discontinuity management with RE repetition in accordance with one or more aspects of the present disclosure. In some cases, the network architecture 200 may be an example of a disaggregated base station architecture or a disaggregated RAN architecture. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some systems, wireless communication devices may use AI/ML models to perform cross-slot DMRS combining. For example, an AI/ML model may estimate a channel using multiple DMRS measurements received via multiple slots. Additionally, or alternatively, any network entity 105 may perform operations supporting phase discontinuity management with RE repetition. For example, a CU 160-a, a DU 165-a, an RU 170-a, or any combination thereof may configure RE repetition across a phase discontinuity gap, may perform RE repetition across a phase discontinuity gap, may perform phase estimation using one or more repeated REs across a phase discontinuity gap, or any combination thereof.

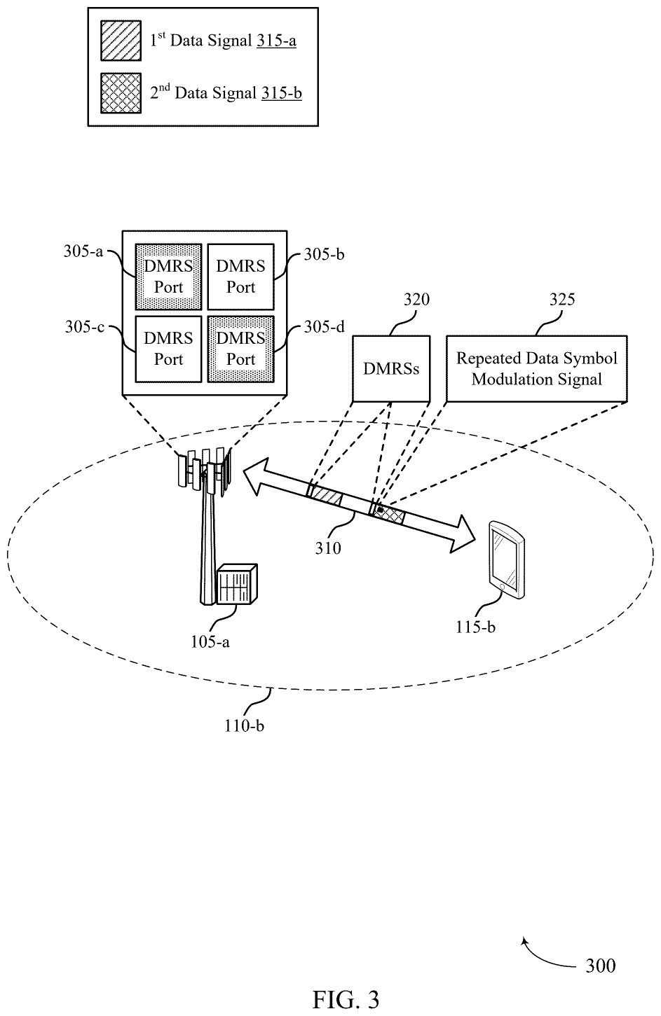

FIG. 3 shows an example of a wireless communications system 300 that supports phase discontinuity management with RE repetition in accordance with one or more aspects of the present disclosure. The wireless communications system 300 may be an example of a wireless communications system 100 or a network architecture 200 as described with reference to FIGS. 1 and 2. The wireless communications system 300 may include a network entity 105-a and a UE 115-b, which may be respective examples of a network entity 105 (e.g., a CU 160, a DU 165, an RU 170, or a combination thereof) and a UE 115 as described with reference to FIGS. 1 and 2. The network entity 105-a or the UE 115-b may update a phase for transmission and may repeat a data symbol modulation signal to support phase estimation for the updated phase.

The network entity 105-a may provide network service for a coverage area 110-b. The network entity 105-a may communicate with the UE 115-b via a communication link 310. For example, the network entity 105-a may transmit one or more downlink signals to the UE 115-b via the communication link 310, the UE 115-b may transmit one or more uplink signals to the network entity 105-a via the communication link 310, or both.

A first wireless communication device, such as the network entity 105-a or the UE 115-b, may transmit a first data signal 315-a via a first slot (e.g., a first transmission time interval (TTI)) and a second data signal 315-b via a second slot (e.g., a second TTI) subsequent to the first slot. For example, the first wireless communication device may be configured to transmit signaling via a physical shared channel (PxSCH), such as a physical downlink shared channel (PDSCH) for the network entity 105-a or a physical uplink shared channel (PUSCH) for the UE 115-b, for the first slot and the second slot.

In some examples, the first wireless communication device may change a phase for transmission between transmitting the first data signal 315-a and transmitting the second data signal 315-b, such that a phase discontinuity occurs between the first data signal 315-a and the second data signal 315-b. The change to the phase causing the phase discontinuity may be referred to as a “phase jump.” A second wireless communication device, such as the UE 115-b or the network entity 105-a, receiving the first data signal 315-a and the second data signal 315-b may fail to maintain phase continuity based on the change to the phase. To determine the updated phase for transmission of the second data signal 315-b, the second wireless communication device may perform phase estimation.

To support phase estimation at the second wireless communication device, the first wireless communication device may transmit a repeated data symbol modulation signal 325 via the second data signal 315-b. For example, the first wireless communication device may repeat one or more PxSCH REs after the phase discontinuity (e.g., across a phase discontinuity gap, in which the phase continuity is not maintained). The first wireless communication device may transmit a data symbol modulation signal via a first PxSCH RE corresponding to a first frequency resource (e.g., a first resource block (RB) or set of RBs) for the first data signal 315-a. If the first wireless communication device adjusts the phase for transmission, causing a phase discontinuity gap, the first wireless communication device may transmit the repeated data symbol modulation signal 325 (e.g., a repetition of the data symbol modulation signal) via a second PxSCH RE corresponding to the same first frequency resource (e.g., the first RB or set of RBs) for the second data signal 315-b. The repeated data symbol modulation signal 325 may support phase estimation based on a comparison of the phase of the data symbol modulation signal before the phase discontinuity gap and the phase of the repeated data symbol modulation signal 325 after the phase discontinuity gap. The first wireless communication device may transmit the repeated data symbol modulation signal 325 via the second data signal 315-b with a same modulation, a same precoding, and a same antenna port (e.g., a same quasi-colocation (QCL)) as the transmission of the data symbol modulation signal via the first data signal 315-a. Accordingly, the first wireless communication device may transmit the repeated data symbol modulation signal 325 using one or more different transmission parameters than the rest of the second data signal 315-b (e.g., based on using a digital precoder, digital beamforming, or both for the transmission parameters). In some cases, the first wireless communication device may change one or more other transmission parameters. For example, the first wireless communication device may transmit the repeated data symbol modulation signal 325 using a different transmit power than the transmission of the data symbol modulation signal via the first data signal 315-a.

In some cases, the first wireless communication device may perform independent phase changes for non-coherent DMRS ports. For example, the first wireless communication device (e.g., the network entity 105-a) may include a first DMRS port 305-a, a second DMRS port 305-b, a third DMRS port 305-c, and a fourth DMRS port 305-d. Multiple DMRS ports may be coherent or non-coherent. For example, the first DMRS port 305-a may be coherent with the fourth DMRS port 305-d but non-coherent with the second DMRS port 305-b and the third DMRS port 305-c.

The second DMRS port 305-b may be coherent with the third DMRS port 305-c, such that the first and fourth DMRS ports form a first set of coherent DMRS ports and the second and third DMRS ports form a second set of coherent DMRS ports noncoherent from the first set of coherent DMRS ports. To support noncoherent sets of DMRS ports, the first wireless communication device may perform PxSCH RE repetition for the noncoherent sets of DMRS ports separately. The second wireless communication device may perform separate phase estimation for the noncoherent sets of DMRS ports using the PxSCH RE repetitions.

In some examples, the phase estimation may support cross-slot DMRS combining at the second wireless communication device. For example, the first wireless communication device may transmit one or more DMRSs 320 via the first slot corresponding to the first data signal 315-a and may transmit one or more DMRSs 320 via the second slot corresponding to the second data signal 315-b. If the second wireless communication device accurately estimates the phase after the phase discontinuity gap, the second wireless communication device may combine the DMRSs 320 received after the phase discontinuity gap (with the updated phase) with the DMRSs 320 received before the phase discontinuity gap (with the initial phase) to improve channel estimation. For example, performing channel estimation using DMRSs 320 received via different slots may improve channel estimation accuracy, reduce DMRS overhead, or both for the wireless communications system 300.

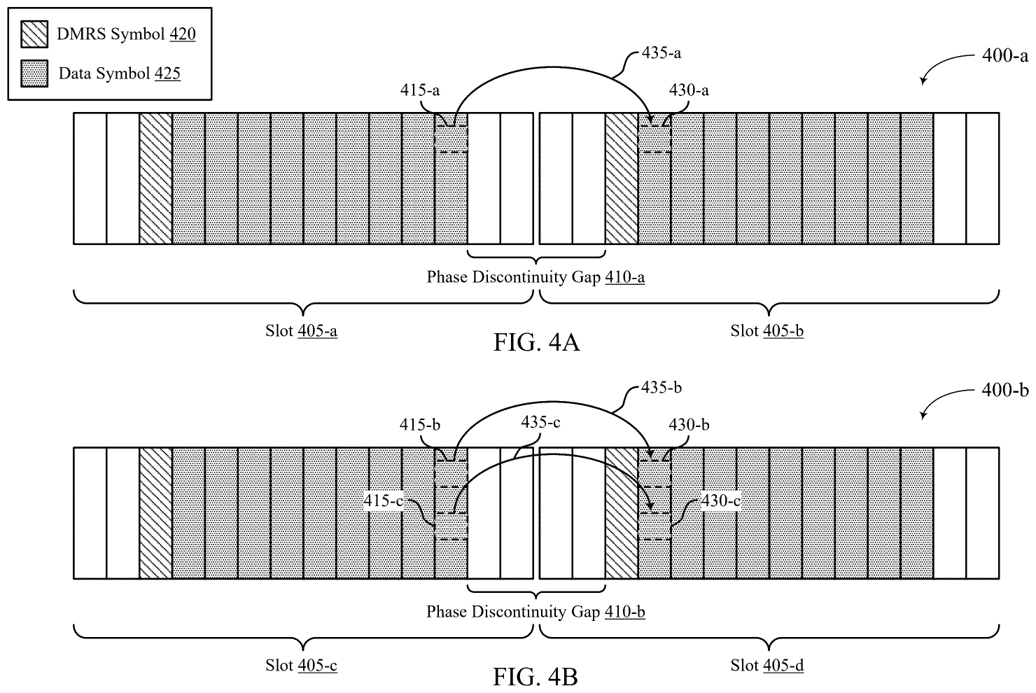

FIGS. 4A and 4B show examples of resource allocations that support phase discontinuity management with RE repetition in accordance with one or more aspects of the present disclosure. FIG. 4A shows an example of a first resource allocation 400-a that supports phase discontinuity management with RE repetition. The first resource allocation 400-a may include a first slot 405-a and a second slot 405-b. A first wireless communication device (e.g., a UE 115 or a network entity 105 as described with reference to FIGS. 1 through 3) may transmit data signaling via the first slot 405-a and the second slot 405-b. To support phase estimation for a phase discontinuity gap 410-a, the first wireless communication device may repeat a data symbol modulation signal 415-a transmitted via the first slot 405-a as a repetition 430-a of the data symbol modulation signal 415-a transmitted via the second slot 405-b. For example, the first resource allocation 400-a may include a physical shared channel (PxSCH) resource element (RE) repetition 435-a across the phase discontinuity gap 410-a. The PxSCH RE repetition 435-a may repeat a first signal (e.g., a PxSCH signal, such as a PDSCH or PUSCH signal) transmitted via a first RE before the phase discontinuity gap 410-a as a second signal via a second RE after the phase discontinuity gap 410-a, where the first signal represents the data symbol modulation signal 415-a and the second signal represents the repetition 430-a of the data symbol modulation signal 415-a.

The first slot 405-a may include one or more DMRS symbols 420 and one or more data symbols 425. The second slot 405-b may similarly include one or more DMRS symbols 420 and one or more data symbols 425. Some systems may support cross-slot DMRS combining. For example, a first wireless communication device may transmit DMRSs via multiple slots (e.g., the first slot 405-a and the second slot 405-b). A second wireless communication device receiving the DMRSs may buffer the DMRSs or channel estimates from one or more previous slots (e.g., the first slot 405-a) and use such DMRSs or channel estimates jointly with DMRSs for a current slot (e.g., the second slot 405-b) to perform channel estimation for the current slot. In some examples, combining DMRSs across slots may improve the DMRS estimation accuracy and, correspondingly, the performance at the second wireless communication device.

Additionally, or alternatively, combining the DMRSs across slots may support a reduction of the DMRS overhead (e.g., the first wireless communication device may reduce a DMRS density), improving channel usage and communication resource efficiency.

In some systems (e.g., if wireless devices are configured with a fluid start and length indicator value (SLIV) design), the first wireless communication device may distribute, such as uniformly distribute, the DMRSs over a time duration for a fluid SLIV (e.g., a time duration for PDSCH, a time duration for PUSCH). The fluid SLIV may indicate a flexible time domain resource allocation for PDSCH transmission or PUSCH transmission. Additionally, or alternatively, the first wireless communication device may distribute the DMRSs across different SLIVs. In some cases, using different SLIVs for time domain allocation may improve flexibility at the first wireless communication device. For example, during a first slot associated with a first SLIV, the first wireless communication device may perform scheduling decisions for a second slot associated with a second SLIV. That is, concurrent to transmission via the first slot, the first wireless communication device may update a resource allocation for a next slot subsequent to the first slot.

If the first wireless communication device determines to perform a phase change during a communication gap (e.g., between communications via the first slot 405-a and the second slot 405-b), the first wireless communication device may perform a PxSCH RE repetition 435-a across the phase discontinuity gap 410-a (e.g., the gap during which the phase change occurs). The first wireless communication device may repeat a subset of PxSCH REs from one or more symbols prior to the phase discontinuity gap 410-a in one or more symbols after the phase discontinuity gap 410-a. For example, the first wireless communication device may transmit a data symbol modulation signal 415-a via a first RE as part of the data symbols 425 of the first slot 405-a. The first wireless communication device may transmit a repetition 430-a of the data symbol modulation signal 415-a via a second RE of the second slot 405-b. In some examples, the first wireless communication device may puncture the second RE from the data symbols 425 of the second slot 405-b to include the repetition 430-a via the punctured second RE. The data symbol modulation signal 415-a before the phase discontinuity gap 410-a and the repetition 430-a of the data symbol modulation signal 415-a after the phase discontinuity gap 410-a may occupy the same PxSCH RE in the frequency domain. As illustrated, in some cases, the repeated RE may correspond to a last data symbol 425 prior to the phase discontinuity gap 410-a and a first data symbol after the phase discontinuity gap 410-a. Alternatively, the repeated RE may correspond to a different data symbol 425 of the first slot 405-a, a different data symbol 425 of the second slot 405-b, or both.

In some cases, the first wireless communication device may perform multiple PxSCH RE repetitions 435-a across the phase discontinuity gap 410-a, for example, according to a pattern. The first wireless communication device may select, or be configured with, a frequency domain PxSCH RE pattern for the PxSCH RE repetition 435-a across the phase discontinuity gap 410-a. In some examples, the frequency domain PxSCH RE pattern may define a quantity of REs to repeat per X contiguous PxSCH RBs, such as one RE per X RBs (where X may be configured via RRC signaling or other control signaling).

The repeated PxSCH RE(s) of the one or more symbols after the phase discontinuity gap 410-a may carry the same modulation symbols (e.g. the same quadrature amplitude modulation (QAM) signals, the same quadrature phase shift keying (QPSK) modulation signals) as the corresponding PxSCH RE(s) of the one or more symbols before the phase discontinuity gap 410-a. A second wireless communication device receiving the repeated PxSCH RE(s) may determine the phase change across the phase discontinuity gap 410-a by computing a phase difference between the repeated modulation symbols. For example, the second wireless communication device may determine a first phase for the data symbol modulation signal 415-a, θ₀, received via the first slot 405-a and a second phase for the repetition 430-a of the data symbol modulation signal 415-a, θ₁, received via the second slot 405-b. The second wireless communication device may calculate, or otherwise estimate, the change in phase as θ₁−θ₀. The second wireless communication device may use the calculated phase change to account for the change in phase when combining DMRS symbols 420 across the slots. The second wireless communication device may perform a channel estimation of the PxSCH for the second slot 405-b using the DMRS symbol 420 of the first slot 405-a, the DMRS symbol 420 of the second slot 405-b, and the phase estimation for the phase change based on the PxSCH RE repetition 435-a.

FIG. 4B shows an example of a second resource allocation 400-b that supports phase discontinuity management with RE repetition. The second resource allocation 400-b may include a first slot 405-c and a second slot 405-d. A first wireless communication device (e.g., a UE 115 or a network entity 105 as described with reference to FIGS. 1 through 3) may transmit data signaling via the first slot 405-c and the second slot 405-d. To support separate phase estimation for different noncoherent DMRS ports across a phase discontinuity gap 410-b, the first wireless communication device may repeat multiple data symbol modulation signals transmitted via the first slot 405-a as repetitions of the data symbol modulation signals transmitted via the second slot 405-b. For example, the second resource allocation 400-b may include separate PxSCH RE repetitions across the phase discontinuity gap 410-b. The PxSCH RE repetition 435-b may repeat a first signal (e.g., a PxSCH signal, such as a PDSCH or PUSCH signal) transmitted via a first RE before the phase discontinuity gap 410-b as a second signal via a second RE after the phase discontinuity gap 410-b, where the first signal represents the data symbol modulation signal 415-b and the second signal represents the repetition 430-b of the data symbol modulation signal 415-b. Additionally, the PxSCH RE repetition 435-c may repeat a third signal transmitted via a third RE before the phase discontinuity gap 410-b as a fourth signal via a fourth RE after the phase discontinuity gap 410-b, where the third signal represents the data symbol modulation signal 415-c and the fourth signal represents the repetition 430-c of the data symbol modulation signal 415-c.

In some examples, the first wireless communication device may transmit the DMRS symbols 420, the data symbols 425, or both using multiple DMRS ports (e.g., multiple transmit ports). Some devices may fail to maintain phase coherency across DMRS ports. For example, a relatively low complexity UE 115 may fail to maintain phase coherency across the DMRS ports, such that the relatively low complexity UE 115 may transmit using at least two DMRS ports that are noncoherent. The phases for transmission by noncoherent DMRS ports may be changed independently, such that a second wireless communication device receiving the DMRSs may estimate separate phase changes per DMRS port (or per group of DMRS ports that are noncoherent with at least another group of DMRS ports).

To support noncoherent DMRS ports, the first wireless communication device may perform PxSCH RE repetition 435-b and PxSCH RE repetition 435-c separately for the noncoherent DMRS ports. For example, the first wireless communication device may repeat M REs per X RBs, where M is the quantity of coherent DMRS port groups. For example, the first wireless communication device may have a first DMRS port 0 that is coherent with a second DMRS port 1, but these DMRS ports may be noncoherent from a third DMRS port 2 and a fourth DMRS port 3, where the third and fourth DMRS ports may be coherent with each other. In such an example, the first wireless communication device may include two sets of coherent DMRS ports: a first set including DMRS ports 0 and 1, and a second set including DMRS ports 2 and 3. The first wireless communication device may repeat two REs per X RBs, where one of the REs corresponds to the first set of coherent DMRS ports and the other RE corresponds to the second set of coherent DMRS ports.

The first wireless communication device may independently handle the phase changes for the noncoherent DMRS port groups by transmitting the repeated REs for the different groups using a single spatial layer. The first wireless communication device may select a designated layer of PxSCH for each DMRS port group for PxSCH RE repetition. For example, the first wireless communication device may transmit a first data symbol modulation signal 415-b via the first slot 405-c using DMRS port 0 (e.g., a first spatial layer) corresponding to the first set of coherent DMRS ports and may transmit a second data symbol modulation signal 415-c via the first slot 405-c using DMRS port 2 (e.g., a second spatial layer) corresponding to the second set of coherent DMRS ports. Similarly, the first wireless communication device may transmit a repetition 430-b of the first data symbol modulation signal 415-b via the second slot 405-d using DMRS port 0 corresponding to the first set of coherent DMRS ports (e.g., the same DMRS port for the initial and repeated RE transmissions) and may transmit a repetition 430-c of the second data symbol modulation signal 415-c via the second slot 405-d using DMRS port 2 corresponding to the second set of coherent DMRS ports (e.g., the same DMRS port for the initial and repeated RE transmissions). Accordingly, the PxSCH RE repetition 435-b may support phase estimation for the first set of coherent DMRS ports, and the PxSCH RE repetition 435-c may support separate phase estimation for the second set of coherent DMRS ports. In some cases, the first wireless communication device and the second wireless communication device may exchange RRC signaling, UE capability signaling, or both to determine the groups of DMRS ports, where a same group includes coherent DMRS ports, and different groups include noncoherent DMRS ports.

The first wireless communication device may perform rate matching for the repeated REs to support the separate phase estimation. For example, the first wireless communication device may rate match one layer of PxSCH to the M REs per X RBs for repetition. For example, one RE of the M REs may support rate matching into the PxSCH of the designated layer selected for the RE repetition. The M REs per X RBs may be repeated across the phase discontinuity gap 410-b and transmitted by the designated layer(s). Accordingly, the second wireless communication device may receive the repeated REs and may calculate phase estimations separately for the different designated layer(s). If the second wireless communication device determines a phase change for one DMRS port within a coherent DMRS port group, the second wireless communication device may use the phase coherency to determine the phase changes for the other DMRS ports of the same coherent DMRS port group.

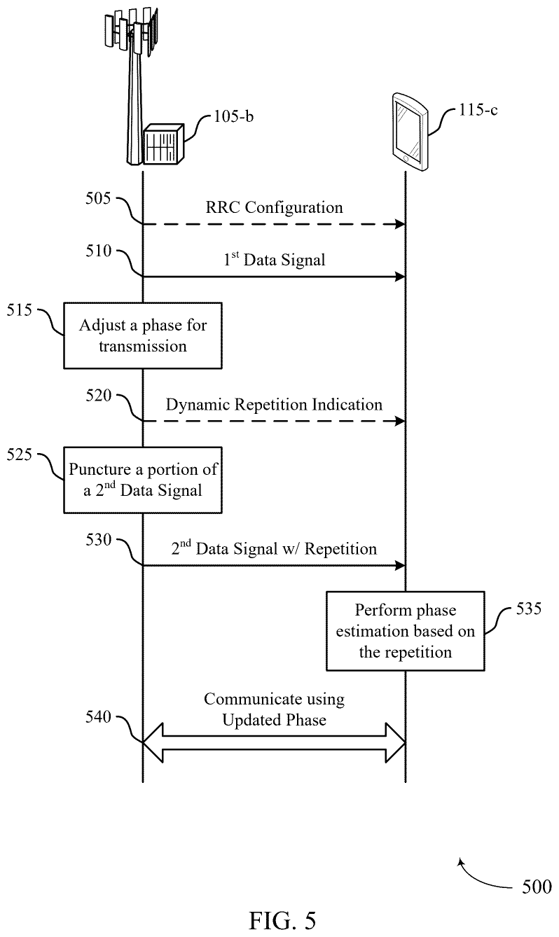

FIG. 5 shows an example of a process flow 500 that supports phase discontinuity management with RE repetition in accordance with one or more aspects of the present disclosure. The process flow 500 may be performed by aspects of the wireless communications system 100, the network architecture 200, or the wireless communications system 300, as described herein with reference to FIGS. 1 through 3. For example, a UE 115-c and a network entity 105-b, which may be respective examples of a UE 115 and a network entity 105 described herein, may perform aspects of the process flow 500. In the following description of the process flow 500, operations performed by the UE 115-c and the network entity 105-b may be performed in a different order than is shown. Some operations may be omitted from the process flow 500, and other operations may be added to the process flow 500. Further, although some operations or signaling may be shown to occur at different times for discussion purposes, these operations may occur at the same time. Additionally, or alternatively, other wireless devices may perform aspects of the process flow 500.

As illustrated in FIG. 5, in some examples, the network entity 105-b may change a phase for signal transmission between PDSCH transmissions. Alternatively, in some other examples, the UE 115-c may change a phase for signal transmission between PUSCH transmissions. In some such other examples, the UE 115-c may perform one or more of the operations described as performed by the network entity 105-b, and the network entity 105-b may perform one or more of the operations described as performed by the UE 115-b with reference to FIG. 5.

In some examples, at 505, the network entity 105-b may transmit, and the UE 115-c may receive, an RRC message that configures a PxSCH RE repetition frequency domain pattern. For example, the network entity 105-b may semi-statically configure the UE 115-c with the PxSCH RE repetition frequency domain pattern via RRC signaling or via other control signaling. In some examples, the network entity 105-b may configure different frequency domain patterns for PDSCH RE repetition and for PUSCH RE repetition. A PxSCH RE repetition frequency domain pattern may configure a quantity of REs per RB used for RE repetition after a phase discontinuity gap, the frequency locations of the repeated REs, the frequency intervals for the repeated REs, or any combination thereof. In some cases, potential phase discontinuity gaps (e.g., potential physical gaps, potential logical gaps, or both) may be known at both the network entity 105-b and the UE 115-c. For example, the RRC signaling may additionally, or alternatively, configure one or more potential phase discontinuity gaps. The RRC signaling may indicate time resources at which a phase change may occur.

At 510, the network entity 105-b may transmit, and the UE 115-c may receive, a first data signal via a first slot. A portion of the first data signal may include a first data symbol modulation signal transmitted via a first RE corresponding to a first frequency resource. The network entity 105-b may additionally transmit one or more DMRSs via the first slot to support channel estimation for the first slot. The one or more DMRSs may further support cross-slot DMRS combining (e.g., with a second slot subsequent to the first slot).

The network entity 105-b may dynamically determine to perform a phase adjustment for transmission. In some examples, the network entity 105-b may select to perform the phase adjustment during the first slot (e.g., during transmission of the first data signal). The network entity 105-b may refrain from reallocating resources of the first slot to account for the phase adjustment. Instead, the network entity 105-b may reallocate resources of the second slot for RE repetition to account for the phase adjustment.

At 515, the network entity 105-b may perform the phase adjustment for transmission. In some cases, this phase adjustment may be referred to as a “phase jump.” The network entity 105-b may perform the phase adjustment during a physical/logical gap, in which phase continuity is not maintained at the UE 115-c.

Accordingly, this “phase discontinuity gap” may occur between the first slot (e.g., a first TTI) and the second slot (e.g., a second TTI). In some examples, the phase discontinuity gap may include one or more symbols of the first slot, one or more symbols of the second slot, or both. In some cases, the phase discontinuity may occur based on a reconfiguration or tuning of one or more transmission parameters by the network entity 105-b at (or around) the slot boundary between the first slot and the second slot. For example, the network entity 105-b may update one or more transmission parameters to improve transmission reliability or performance (e.g., based on channel conditions, UE or network entity mobility, congestion, or any other changing conditions). The network entity 105-b may determine to perform PxSCH RE repetition, such as PDSCH RE repetition via the second slot, in accordance with the phase discontinuity gap.

In some examples, at 520, the network entity 105-b may transmit, and the UE 115-c may receive, a dynamic indication of the PxSCH RE repetition to the UE 115-c. The indication of the PxSCH RE repetition via the second slot may inherently also indicate puncturing of data from the second slot (e.g., to fit the RE repetition). If the PxSCH RE repetition is based on a configured potential phase discontinuity gap, the network entity 105-b may transmit a DCI message indicating that the “potential” phase discontinuity gap is used (e.g., as an “actual” phase discontinuity gap). In some examples, the network entity 105-b may transmit the DCI message via the second slot (e.g., prior to one or more DMRSs of the second slot, embedded with the one or more DMRSs of the second slot, prior to a second data signal of the second slot). In some cases, the DCI message may include a flag indicating whether or not the potential phase discontinuity gap actually occurs (e.g., a first bit value indicating that the phase discontinuity gap occurs, a second bit value indicating that the phase discontinuity gap does not occur). Alternatively, if the PxSCH RE repetition is based on a dynamic phase discontinuity gap (e.g., dynamically scheduled, rather than aligning with a known potential phase discontinuity gap), the network entity 105-b may transmit one or more DCI messages indicating a time location (e.g., symbol) of the RE repetition, the dynamic phase discontinuity gap, or both. For example, the one or more DCI messages may indicate the PxSCH RE repetition, a symbol offset of the PxSCH RE repetition with respect to the DCI message, or both. In some cases, the network entity 105-b may transmit separate DCI messages indicating the PxSCH RE repetition and the symbol offset of the PxSCH RE repetition with respect to a DCI message. In some cases, if the UE 115-c is alternatively performing the RE repetition, the UE 115-c may use one or more UCI messages to dynamically indicate the RE repetition.

At 525, the network entity 105-b may puncture a portion of a second data signal based on the RE repetition. For example, the network entity 105-b may puncture a second RE from the second data signal corresponding to (e.g., aligning in frequency with) a first RE from the first data signal. The network entity 105-b may repeat a data symbol modulation signal from the first RE in the punctured second RE.

At 530, the network entity 105-b may transmit, and the UE 115-c may receive, the second data signal via the second slot subsequent to the first slot. The second data signal may include the repetition of the data symbol modulation signal via the second RE (e.g., the punctured RE). The network entity 105-b may transmit the repetition of the data symbol modulation signal based on the phase discontinuity gap between the first slot and the second slot. The network entity 105-b may additionally transmit one or more DMRSs via the second slot to support channel estimation for the second slot.

At 535, the UE 115-c may perform phase estimation based on the repetition of the data symbol modulation signal. For example, the UE 115-c may compare a first phase of the data symbol modulation signal received via the first slot with a second phase of the repetition of the data symbol modulation signal received via the second slot to determine a change in the phase at the phase discontinuity gap. The UE 115-c may use the phase estimation, in addition to one or more DMRSs received via the second slot and one or more DMRSs received via the first slot, to perform cross-slot DMRS combining for channel estimation.

At 540, the UE 115-c and the network entity 105-b may communicate signaling in accordance with the updated phase based on the channel estimation. For example, the UE 115-c may improve the channel estimation by using DMRSs from multiple slots and accounting for the phase discontinuity using the RE repetition. The UE 115-c and the network entity 105-b may improve communication reliability, performance, or both based on the improved channel estimation.

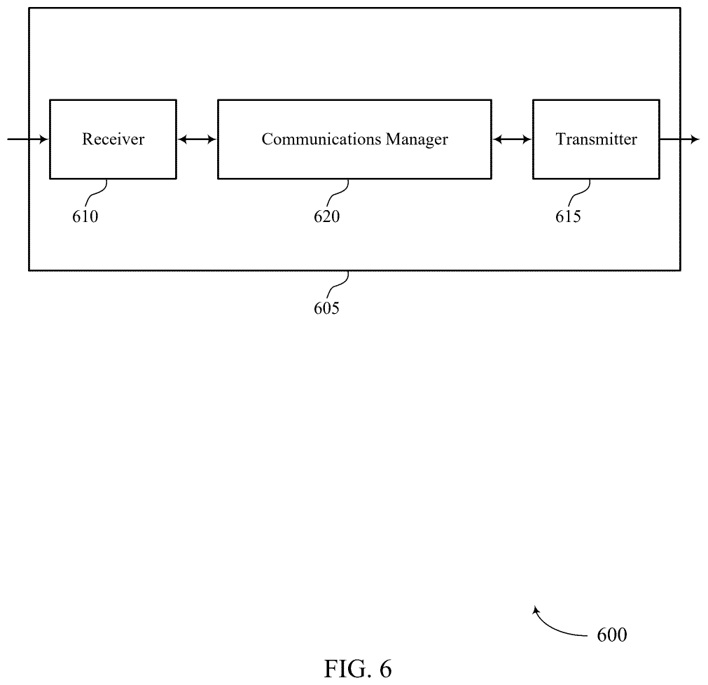

FIG. 6 shows a block diagram 600 of a device 605 that supports phase discontinuity management with RE repetition in accordance with one or more aspects of the present disclosure. The device 605 may be an example of aspects of a UE 115 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to phase discontinuity management with RE repetition). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to phase discontinuity management with RE repetition). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of phase discontinuity management with RE repetition as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting, via a first slot, a first data signal, a portion of the first data signal including a data symbol modulation signal transmitted via a first RE corresponding to a first frequency resource. The communications manager 620 is capable of, configured to, or operable to support a means for transmitting, via a second slot subsequent to the first slot, a repetition of the data symbol modulation signal via a second RE corresponding to the first frequency resource, where the transmitting the repetition of the data symbol modulation signal is based on the first slot and the second slot having phase discontinuity. The communications manager 620 is capable of, configured to, or operable to support a means for communicating signaling in accordance with the phase discontinuity based on the repetition of the data symbol modulation signal.

Additionally, or alternatively, the communications manager 620 may support wireless communications in accordance with examples as disclosed herein. For example, the communications manager 620 is capable of, configured to, or operable to support a means for receiving, via a first slot, a first data signal, a portion of the first data signal including a data symbol modulation signal received via a first RE corresponding to a first frequency resource. The communications manager 620 is capable of, configured to, or operable to support a means for receiving, via a second slot subsequent to the first slot, a repetition of the data symbol modulation signal via a second RE corresponding to the first frequency resource, where the receiving the repetition of the data symbol modulation signal is based on the first slot and the second slot having phase discontinuity. The communications manager 620 is capable of, configured to, or operable to support a means for communicating signaling in accordance with a phase estimation of the phase discontinuity based on the repetition of the data symbol modulation signal.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for improved utilization of communication resources. For example, the device 605 may reduce a quantity of REs used to support phase estimation, improving resource efficiency. Additionally, or alternatively, the device 605 may reduce a processing timeline associated with a change in phase. For example, the device 605 may dynamically determine, during a slot, to perform a phase adjustment without affecting the data transmission (e.g., the resource allocation) for the slot. Instead, the device 605 may reallocate resources of a next slot to include the repetition of the data symbol modulation signal, supporting phase estimation using the repetition.

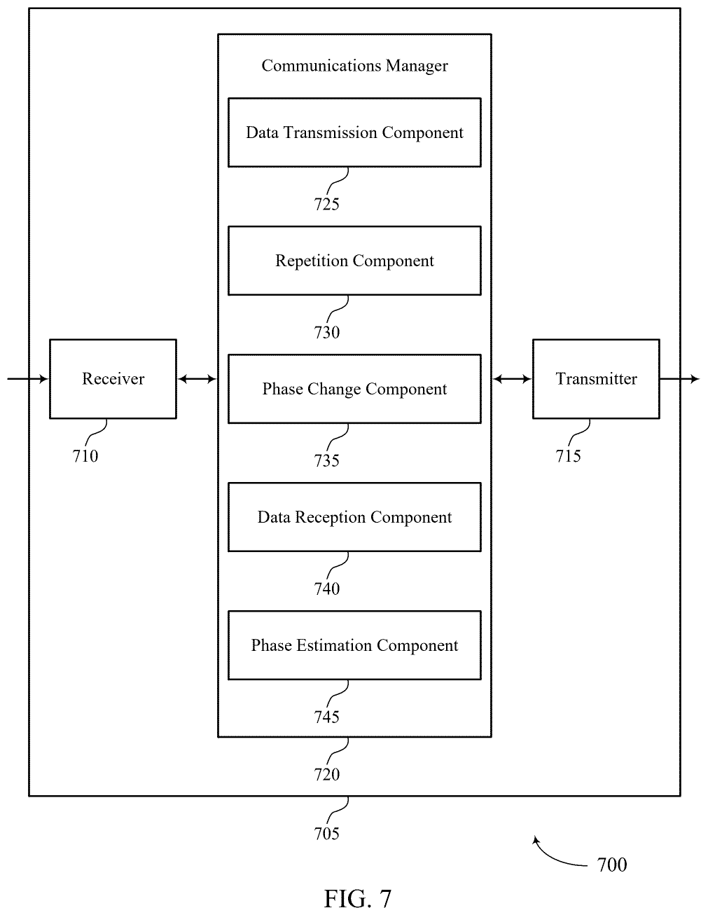

FIG. 7 shows a block diagram 700 of a device 705 that supports phase discontinuity management with RE repetition in accordance with one or more aspects of the present disclosure. The device 705 may be an example of aspects of a device 605, a UE 115, or a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to phase discontinuity management with RE repetition). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to phase discontinuity management with RE repetition). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of phase discontinuity management with RE repetition as described herein. For example, the communications manager 720 may include a data transmission component 725, a repetition component 730, a phase change component 735, a data reception component 740, a phase estimation component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The data transmission component 725 is capable of, configured to, or operable to support a means for transmitting, via a first slot, a first data signal, a portion of the first data signal including a data symbol modulation signal transmitted via a first RE corresponding to a first frequency resource. The repetition component 730 is capable of, configured to, or operable to support a means for transmitting, via a second slot subsequent to the first slot, a repetition of the data symbol modulation signal via a second RE corresponding to the first frequency resource, where the transmitting the repetition of the data symbol modulation signal is based on the first slot and the second slot having phase discontinuity. The phase change component 735 is capable of, configured to, or operable to support a means for communicating signaling in accordance with the phase discontinuity based on the repetition of the data symbol modulation signal.

Additionally, or alternatively, the communications manager 720 may support wireless communications in accordance with examples as disclosed herein. The data reception component 740 is capable of, configured to, or operable to support a means for receiving, via a first slot, a first data signal, a portion of the first data signal including a data symbol modulation signal received via a first RE corresponding to a first frequency resource. The repetition component 730 is capable of, configured to, or operable to support a means for receiving, via a second slot subsequent to the first slot, a repetition of the data symbol modulation signal via a second RE corresponding to the first frequency resource, where the receiving the repetition of the data symbol modulation signal is based on the first slot and the second slot having phase discontinuity. The phase estimation component 745 is capable of, configured to, or operable to support a means for communicating signaling in accordance with a phase estimation of the phase discontinuity based on the repetition of the data symbol modulation signal.

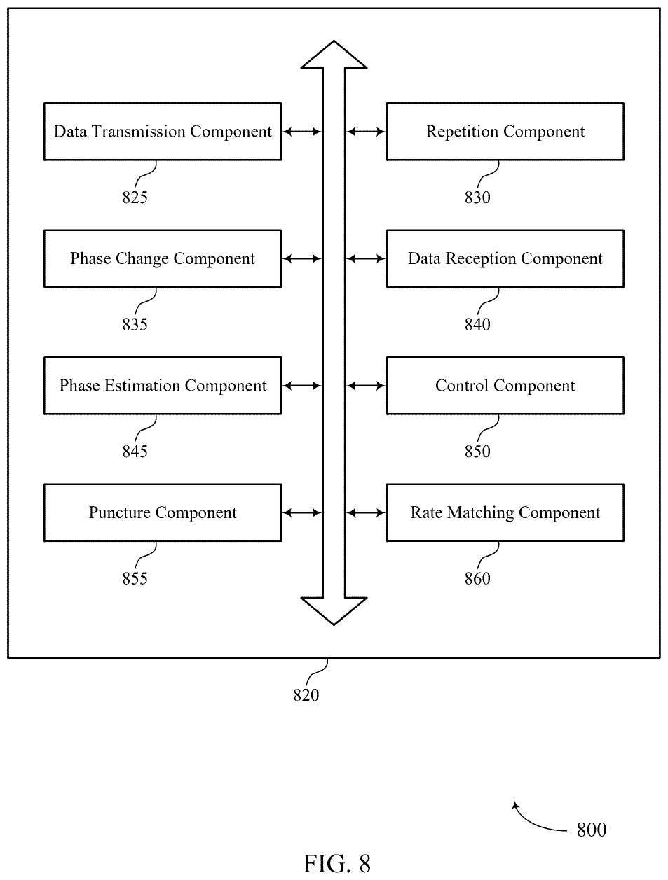

FIG. 8 shows a block diagram 800 of a communications manager 820 that supports phase discontinuity management with RE repetition in accordance with one or more aspects of the present disclosure. The communications manager 820 may be an example of aspects of a communications manager 620, a communications manager 720, or both, as described herein. The communications manager 820, or various components thereof, may be an example of means for performing various aspects of phase discontinuity management with RE repetition as described herein. For example, the communications manager 820 may include a data transmission component 825, a repetition component 830, a phase change component 835, a data reception component 840, a phase estimation component 845, a control component 850, a puncture component 855, a rate matching component 860, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The data transmission component 825 is capable of, configured to, or operable to support a means for transmitting, via a first slot, a first data signal, a portion of the first data signal including a data symbol modulation signal transmitted via a first RE corresponding to a first frequency resource. The repetition component 830 is capable of, configured to, or operable to support a means for transmitting, via a second slot subsequent to the first slot, a repetition of the data symbol modulation signal via a second RE corresponding to the first frequency resource, where the transmitting the repetition of the data symbol modulation signal is based on the first slot and the second slot having phase discontinuity. The phase change component 835 is capable of, configured to, or operable to support a means for communicating signaling in accordance with the phase discontinuity based on the repetition of the data symbol modulation signal.

In some examples, the control component 850 is capable of, configured to, or operable to support a means for communicating an RRC message indicating an RE repetition frequency domain pattern, where transmitting the repetition of the data symbol modulation signal is in accordance with the RE repetition frequency domain pattern.

In some examples, the control component 850 is capable of, configured to, or operable to support a means for transmitting a control information message dynamically indicating the repetition of the data symbol modulation signal based on the first slot and the second slot having the phase discontinuity. In some other examples, the control component 850 is capable of, configured to, or operable to support a means for transmitting one or more control information messages dynamically indicating the repetition of the data symbol modulation signal and a time domain resource of the second RE based on the first slot and the second slot having the phase discontinuity.

In some examples, the data symbol modulation signal and the repetition of the data symbol modulation signal are transmitted using a same precoder.

In some examples, the puncture component 855 is capable of, configured to, or operable to support a means for puncturing a second portion of a second data signal associated with the second slot. In some examples, to transmit the repetition of the data symbol modulation signal, the data transmission component 825 is capable of, configured to, or operable to support a means for transmitting, via the second slot, the second data signal, the second portion of the second data signal including the repetition of the data symbol modulation signal transmitted via the second RE corresponding to the first frequency resource based on the puncturing. In some examples, the first RE corresponds to a last symbol of the first data signal transmitted via the first slot preceding a phase discontinuity gap associated with the first slot and the second slot having the phase discontinuity, and the second RE corresponds to a first symbol of the second data signal transmitted via the second slot subsequent to the phase discontinuity gap. In some examples, the data symbol modulation signal and the repetition of the data symbol modulation signal are transmitted using a first precoder associated with the first data signal, where an unpunctured portion of the second data signal is transmitted using a second precoder associated with the second data signal and different from the first precoder.

In some examples, to support transmitting the repetition of the data symbol modulation signal, the repetition component 830 is capable of, configured to, or operable to support a means for transmitting, via the second slot, a set of multiple repetitions of respective data symbol modulation signals in accordance with an RE repetition frequency domain pattern indicating a repetition density of REs per set of RBs, the first data signal including the respective data symbol modulation signals.

In some examples, the repetition of the data symbol modulation signal includes a first repetition of a first data symbol modulation signal corresponding to a first set of coherent DMRS ports, and the repetition component 830 is capable of, configured to, or operable to support a means for transmitting, via the second slot, a second repetition of a second data symbol modulation signal corresponding to a second set of coherent DMRS ports, a second portion of the first data signal including the second data symbol modulation signal, where the communicating the signaling is in accordance with a first phase discontinuity based on the first repetition of the first data symbol modulation signal and a second phase discontinuity based on the second repetition of the second data symbol modulation signal.

In some examples, to support transmitting the first data signal, the rate matching component 860 is capable of, configured to, or operable to support a means for rate matching the portion of the first data signal including the first data symbol modulation signal according to a first spatial layer associated with the first set of coherent DMRS ports. In some such examples, to support transmitting the first data signal, the rate matching component 860 is capable of, configured to, or operable to support a means for rate matching the second portion of the first data signal including the second data symbol modulation signal according to a second spatial layer associated with the second set of coherent DMRS ports.

In some examples, to support transmitting the first repetition of the first data symbol modulation signal and transmitting the second repetition of the second data symbol modulation signal, the repetition component 830 is capable of, configured to, or operable to support a means for transmitting, via the second slot, a first set of multiple repetitions of respective first data symbol modulation signals corresponding to the first set of coherent DMRS ports and a second set of multiple repetitions of respective second data symbol modulation signals corresponding to the second set of coherent DMRS ports, where the transmitting the first set of multiple repetitions and the second set of multiple repetitions is in accordance with an RE repetition frequency domain pattern indicating a repetition density of REs per set of RBs for both the first set of multiple repetitions and the second set of multiple repetitions, and the first data signal includes the respective first data symbol modulation signals and the respective second data symbol modulation signals.

In some examples, the phase change component 835 is capable of, configured to, or operable to support a means for determining, concurrent to the transmitting the first data signal via the first slot, to change a phase between the first slot and the second slot, where the transmitting the repetition of the data symbol modulation signal is further based on the determining.

In some examples, the data symbol modulation signal includes a QAM signal or a QPSK modulation signal.

Additionally, or alternatively, the communications manager 820 may support wireless communications in accordance with examples as disclosed herein. The data reception component 840 is capable of, configured to, or operable to support a means for receiving, via a first slot, a first data signal, a portion of the first data signal including a data symbol modulation signal received via a first RE corresponding to a first frequency resource. In some examples, the repetition component 830 is capable of, configured to, or operable to support a means for receiving, via a second slot subsequent to the first slot, a repetition of the data symbol modulation signal via a second RE corresponding to the first frequency resource, where the receiving the repetition of the data symbol modulation signal is based on the first slot and the second slot having phase discontinuity. The phase estimation component 845 is capable of, configured to, or operable to support a means for communicating signaling in accordance with a phase estimation of the phase discontinuity based on the repetition of the data symbol modulation signal.

In some examples, the phase estimation component 845 is capable of, configured to, or operable to support a means for comparing the data symbol modulation signal received via the first RE and the repetition of the data symbol modulation signal received via the second RE to obtain the phase estimation.

In some examples, the control component 850 is capable of, configured to, or operable to support a means for communicating an RRC message indicating an RE repetition frequency domain pattern, where the receiving the repetition of the data symbol modulation signal is in accordance with the RE repetition frequency domain pattern.

In some examples, the control component 850 is capable of, configured to, or operable to support a means for receiving a control information message dynamically indicating the repetition of the data symbol modulation signal based on the first slot and the second slot having the phase discontinuity. In some other examples, the control component 850 is capable of, configured to, or operable to support a means for receiving one or more control information messages dynamically indicating the repetition of the data symbol modulation signal and a time domain resource of the second RE based on the first slot and the second slot having the phase discontinuity.

In some examples, to support receiving the repetition of the data symbol modulation signal, the data reception component 840 is capable of, configured to, or operable to support a means for receiving, via the second slot, a second data signal, a second portion of the second data signal punctured with the repetition of the data symbol modulation signal. In some examples, the first RE corresponds to a last symbol of the first data signal received via the first slot preceding a phase discontinuity gap associated with the phase discontinuity, and the second RE corresponds to a first symbol of the second data signal received via the second slot subsequent to the phase discontinuity gap.

In some examples, to support receiving the repetition of the data symbol modulation signal, the repetition component 830 is capable of, configured to, or operable to support a means for receiving, via the second slot, a set of multiple repetitions of respective data symbol modulation signals in accordance with an RE repetition frequency domain pattern indicating a repetition density of REs per set of RBs, the first data signal including the respective data symbol modulation signals.

In some examples, the repetition of the data symbol modulation signal includes a first repetition of a first data symbol modulation signal corresponding to a first set of coherent DMRS ports, and the repetition component 830 is capable of, configured to, or operable to support a means for receiving, via the second slot, a second repetition of a second data symbol modulation signal corresponding to a second set of coherent DMRS ports, a second portion of the first data signal including the second data symbol modulation signal, where the communicating the signaling is in accordance with a first phase estimation of a first phase discontinuity based on the first repetition of the first data symbol modulation signal and a second phase estimation of a second phase discontinuity based on the second repetition of the second data symbol modulation signal.

In some examples, to support receiving the first repetition of the first data symbol modulation signal and receiving the second repetition of the second data symbol modulation signal, the repetition component 830 is capable of, configured to, or operable to support a means for receiving, via the second slot, a first set of multiple repetitions of respective first data symbol modulation signals corresponding to the first set of coherent DMRS ports and a second set of multiple repetitions of respective second data symbol modulation signals corresponding to the second set of coherent DMRS ports, where receiving the first set of multiple repetitions and the second set of multiple repetitions is in accordance with an RE repetition frequency domain pattern indicating a repetition density of REs per set of RBs for both the first set of multiple repetitions and the second set of multiple repetitions, and the first data signal includes the respective first data symbol modulation signals and the respective second data symbol modulation signals.

In some examples, the data symbol modulation signal includes a QAM signal or a QPSK modulation signal.

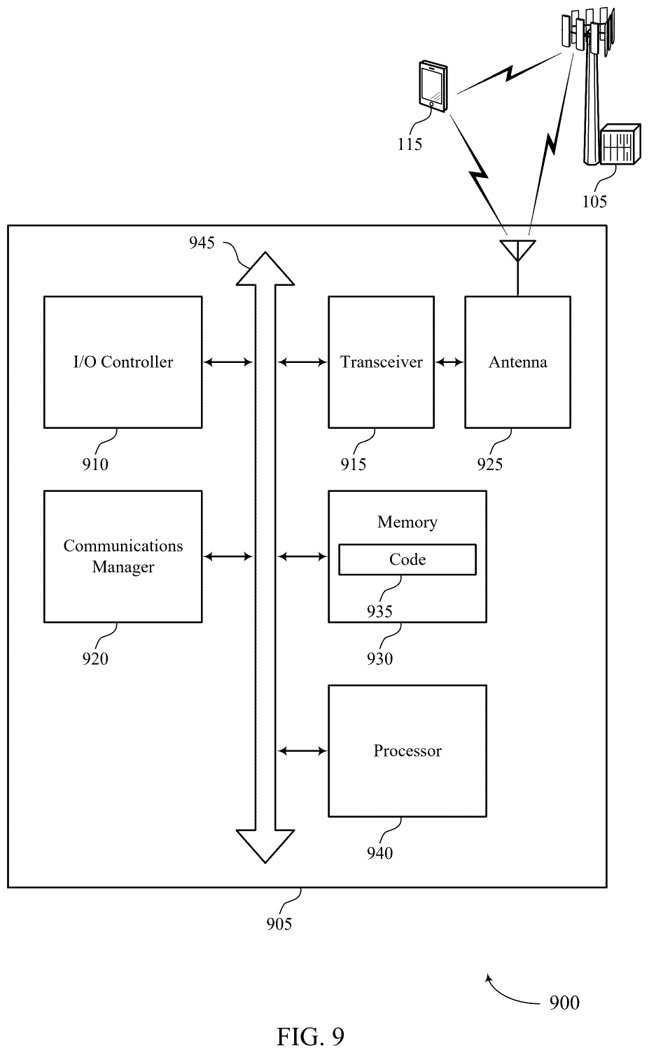

FIG. 9 shows a diagram of a system 900 including a device 905 that supports phase discontinuity management with RE repetition in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting phase discontinuity management with RE repetition). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting, via a first slot, a first data signal, a portion of the first data signal including a data symbol modulation signal transmitted via a first RE corresponding to a first frequency resource. The communications manager 920 is capable of, configured to, or operable to support a means for transmitting, via a second slot subsequent to the first slot, a repetition of the data symbol modulation signal via a second RE corresponding to the first frequency resource, where the transmitting the repetition of the data symbol modulation signal is based on the first slot and the second slot having phase discontinuity. The communications manager 920 is capable of, configured to, or operable to support a means for communicating signaling in accordance with the phase discontinuity based on the repetition of the data symbol modulation signal.

Additionally, or alternatively, the communications manager 920 may support wireless communications in accordance with examples as disclosed herein. For example, the communications manager 920 is capable of, configured to, or operable to support a means for receiving, via a first slot, a first data signal, a portion of the first data signal including a data symbol modulation signal received via a first RE corresponding to a first frequency resource. The communications manager 920 is capable of, configured to, or operable to support a means for receiving, via a second slot subsequent to the first slot, a repetition of the data symbol modulation signal via a second RE corresponding to the first frequency resource, where the receiving the repetition of the data symbol modulation signal is based on the first slot and the second slot having phase discontinuity. The communications manager 920 is capable of, configured to, or operable to support a means for communicating signaling in accordance with a phase estimation of the phase discontinuity based on the repetition of the data symbol modulation signal.

By including or configuring the communications manager 920 in accordance with examples as described herein, the device 905 may support techniques for improved communication reliability, improved DMRS overhead, more efficient utilization of communication resources, improved coordination between devices, or a combination thereof.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of phase discontinuity management with RE repetition as described herein, or the at least one processor 940 and the at least one memory 930 may be otherwise configured to, individually or collectively, perform or support such operations.

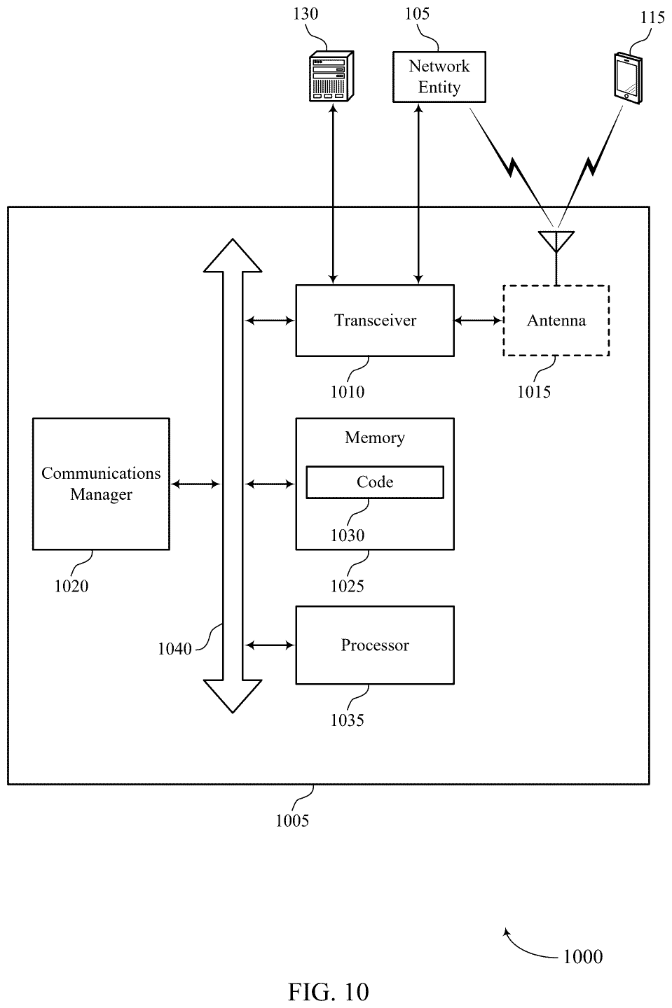

FIG. 10 shows a diagram of a system 1000 including a device 1005 that supports phase discontinuity management with RE repetition in accordance with one or more aspects of the present disclosure. The device 1005 may be an example of or include components of a device 605, a device 705, or a network entity 105 as described herein. The device 1005 may communicate with other network devices or network equipment such as one or more of the network entities 105, UEs 115, or any combination thereof. The communications may include communications over one or more wired interfaces, over one or more wireless interfaces, or any combination thereof. The device 1005 may include components that support outputting and obtaining communications, such as a communications manager 1020, a transceiver 1010, one or more antennas 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting phase discontinuity management with RE repetition). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025).

In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with one or more other network entities 105 and may include a controller or scheduler for controlling communications with UEs 115 (e.g., in cooperation with the one or more other network devices). In some examples, the communications manager 1020 may support an X2 interface within an LTE/LTE-A wireless communications network technology to provide communication between network entities 105.

The communications manager 1020 may support wireless communications in accordance with examples as disclosed herein. For example, the communications manager 1020 is capable of, configured to, or operable to support a means for transmitting, via a first slot, a first data signal, a portion of the first data signal including a data symbol modulation signal transmitted via a first RE corresponding to a first frequency resource. The communications manager 1020 is capable of, configured to, or operable to support a means for transmitting, via a second slot subsequent to the first slot, a repetition of the data symbol modulation signal via a second RE corresponding to the first frequency resource, where the transmitting the repetition of the data symbol modulation signal is based on the first slot and the second slot having phase discontinuity. The communications manager 1020 is capable of, configured to, or operable to support a means for communicating signaling in accordance with the phase discontinuity based on the repetition of the data symbol modulation signal.

Additionally, or alternatively, the communications manager 1020 may support wireless communications in accordance with examples as disclosed herein. For example, the communications manager 1020 is capable of, configured to, or operable to support a means for receiving, via a first slot, a first data signal, a portion of the first data signal including a data symbol modulation signal received via a first RE corresponding to a first frequency resource. The communications manager 1020 is capable of, configured to, or operable to support a means for receiving, via a second slot subsequent to the first slot, a repetition of the data symbol modulation signal via a second RE corresponding to the first frequency resource, where the receiving the repetition of the data symbol modulation signal is based on the first slot and the second slot having phase discontinuity. The communications manager 1020 is capable of, configured to, or operable to support a means for communicating signaling in accordance with a phase estimation of the phase discontinuity based on the repetition of the data symbol modulation signal.

By including or configuring the communications manager 1020 in accordance with examples as described herein, the device 1005 may support techniques for improved communication reliability, improved DMRS overhead, more efficient utilization of communication resources, improved coordination between devices, or a combination thereof.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of phase discontinuity management with RE repetition as described herein, or the at least one processor 1035 and the at least one memory 1025 may be otherwise configured to, individually or collectively, perform or support such operations.

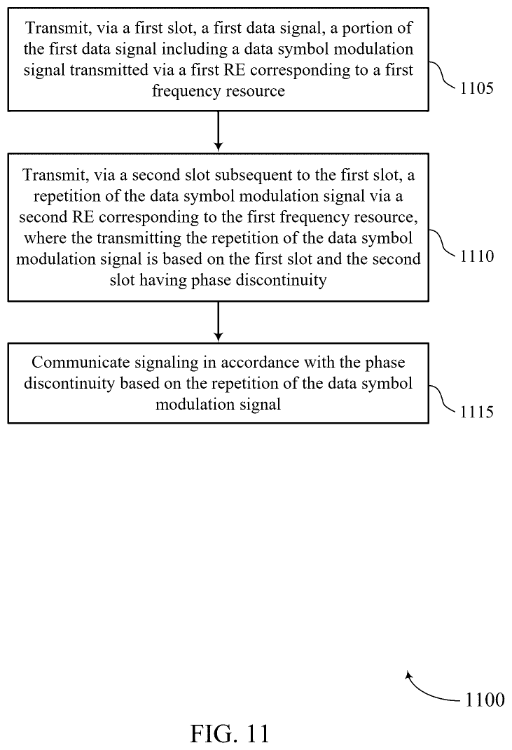

FIG. 11 shows a flowchart illustrating a method 1100 that supports phase discontinuity management with RE repetition in accordance with one or more aspects of the present disclosure. The operations of the method 1100 may be implemented by a first wireless communication device, such as a UE, a network entity, or components of a UE or network entity as described herein. For example, the operations of the method 1100 may be performed by a UE 115 or a network entity 105 as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include transmitting, via a first slot, a first data signal. A portion of the first data signal may include a data symbol modulation signal transmitted via a first RE corresponding to a first frequency resource. The operations of 1105 may be performed in accordance with examples as disclosed herein, such as the transmission of a first data signal 315-a as described with reference to FIG. 3, the transmission of data symbols 425 via the first slot 405-a as described with reference to FIG. 4A, the transmission of a first data signal at 510 as described with reference to FIG. 5, or any combination thereof. In some examples, aspects of the operations of 1105 may be performed by a data transmission component 825 as described with reference to FIG. 8.

At 1110, the method may include transmitting, via a second slot subsequent to the first slot, a repetition of the data symbol modulation signal via a second RE corresponding to the first frequency resource. The transmitting the repetition of the data symbol modulation signal may be based on the first slot and the second slot having phase discontinuity. The operations of 1110 may be performed in accordance with examples as disclosed herein, such as the transmission of a repeated data symbol modulation signal 325 via a second data signal 315-b as described with reference to FIG. 3, the transmission of a repetition 430-a of a data symbol modulation signal 415-a via the second slot 405-b as described with reference to FIG. 4A, the transmission of a second data signal with an RE repetition at 530 as described with reference to FIG. 5, or any combination thereof. In some examples, aspects of the operations of 1110 may be performed by a repetition component 830 as described with reference to FIG. 8.

At 1115, the method may include communicating signaling in accordance with the phase discontinuity based on the repetition of the data symbol modulation signal. The operations of 1115 may be performed in accordance with examples as disclosed herein, such as the communication of signaling using an updated phase at 540 as described with reference to FIG. 5. In some examples, aspects of the operations of 1115 may be performed by a phase change component 835 as described with reference to FIG. 8.

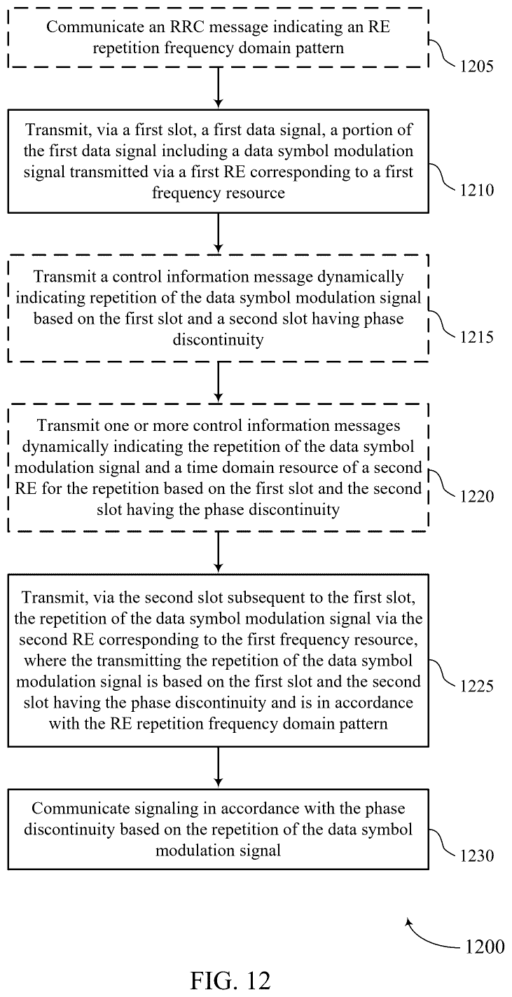

FIG. 12 shows a flowchart illustrating a method 1200 that supports phase discontinuity management with RE repetition in accordance with one or more aspects of the present disclosure. The operations of the method 1200 may be implemented by a first wireless communication device, such as a UE, a network entity, or components of a UE or network entity as described herein. For example, the operations of the method 1200 may be performed by a UE 115 or a network entity 105 as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include communicating an RRC message indicating an RE repetition frequency domain pattern. The operations of 1205 may be performed in accordance with examples as disclosed herein, such as the transmission of RRC configuration signaling at 505 as described with reference to FIG. 5. In some examples, aspects of the operations of 1205 may be performed by a control component 850 as described with reference to FIG. 8.

At 1210, the method may include transmitting, via a first slot, a first data signal. A portion of the first data signal may include a data symbol modulation signal transmitted via a first RE corresponding to a first frequency resource. The operations of 1210 may be performed in accordance with examples as disclosed herein, such as the transmission of a first data signal 315-a as described with reference to FIG. 3, the transmission of data symbols 425 via the first slot 405-a as described with reference to FIG. 4A, the transmission of a first data signal at 510 as described with reference to FIG. 5, or any combination thereof. In some examples, aspects of the operations of 1210 may be performed by a data transmission component 825 as described with reference to FIG. 8.

In some examples, at 1215, the method may include transmitting a control information message dynamically indicating repetition of the data symbol modulation signal based on the first slot and a second slot having phase discontinuity. The operations of 1215 may be performed in accordance with examples as disclosed herein, such as the transmission of a dynamic repetition indication via DCI or UCI signaling at 520 as described with reference to FIG. 5. In some examples, aspects of the operations of 1215 may be performed by a control component 850 as described with reference to FIG. 8.

In some other examples, at 1220, the method may include transmitting one or more control information messages dynamically indicating the repetition of the data symbol modulation signal and a time domain resource of a second RE for the repetition based on the first slot and the second slot having the phase discontinuity. The operations of 1220 may be performed in accordance with examples as disclosed herein, such as the transmission of a dynamic repetition indication via DCI or UCI signaling at 520 as described with reference to FIG. 5. In some examples, aspects of the operations of 1220 may be performed by a control component 850 as described with reference to FIG. 8.

At 1225, the method may include transmitting, via the second slot subsequent to the first slot, the repetition of the data symbol modulation signal via the second RE corresponding to the first frequency resource. The transmitting the repetition of the data symbol modulation signal may be based on the first slot and the second slot having the phase discontinuity and may be in accordance with the RE repetition frequency domain pattern. The operations of 1225 may be performed in accordance with examples as disclosed herein, such as the transmission of a repeated data symbol modulation signal 325 via a second data signal 315-b as described with reference to FIG. 3, the transmission of a repetition 430-a of a data symbol modulation signal 415-a via the second slot 405-b as described with reference to FIG. 4A, the transmission of a second data signal with an RE repetition at 530 as described with reference to FIG. 5, or any combination thereof. In some examples, aspects of the operations of 1225 may be performed by a repetition component 830 as described with reference to FIG. 8.

At 1230, the method may include communicating signaling in accordance with the phase discontinuity based on the repetition of the data symbol modulation signal. The operations of 1230 may be performed in accordance with examples as disclosed herein, such as the communication of signaling using an updated phase at 540 as described with reference to FIG. 5. In some examples, aspects of the operations of 1230 may be performed by a phase change component 835 as described with reference to FIG. 8.

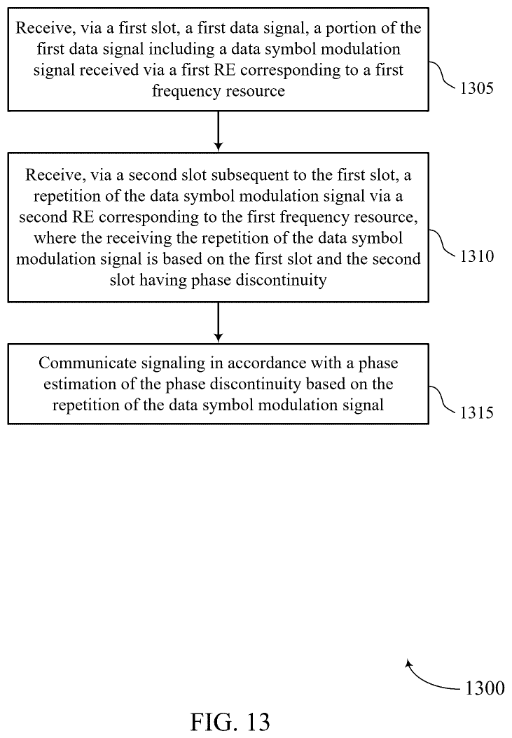

FIG. 13 shows a flowchart illustrating a method 1300 that supports phase discontinuity management with RE repetition in accordance with one or more aspects of the present disclosure. The operations of the method 1300 may be implemented by a second wireless communication device, such as a UE, a network entity, or components of a UE or network entity as described herein. For example, the operations of the method 1300 may be performed by a UE 115 or a network entity 105 as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include receiving, via a first slot, a first data signal. A portion of the first data signal may include a data symbol modulation signal received via a first RE corresponding to a first frequency resource. The operations of 1305 may be performed in accordance with examples as disclosed herein, such as the reception of a first data signal 315-a as described with reference to FIG. 3, the reception of data symbols 425 via the first slot 405-a as described with reference to FIG. 4A, the reception of a first data signal at 510 as described with reference to FIG. 5, or any combination there. In some examples, aspects of the operations of 1305 may be performed by a data reception component 840 as described with reference to FIG. 8.

At 1310, the method may include receiving, via a second slot subsequent to the first slot, a repetition of the data symbol modulation signal via a second RE corresponding to the first frequency resource. The receiving the repetition of the data symbol modulation signal may be based on the first slot and the second slot having phase discontinuity. The operations of 1310 may be performed in accordance with examples as disclosed herein, such as the reception of a repeated data symbol modulation signal 325 via a second data signal 315-b as described with reference to FIG. 3, the reception of a repetition 430-a of a data symbol modulation signal 415-a via the second slot 405-b as described with reference to FIG. 4A, the reception of a second data signal with an RE repetition at 530 as described with reference to FIG. 5, or any combination thereof. In some examples, aspects of the operations of 1310 may be performed by a repetition component 830 as described with reference to FIG. 8.

At 1315, the method may include communicating signaling in accordance with a phase estimation of the phase discontinuity based on the repetition of the data symbol modulation signal. The operations of 1315 may be performed in accordance with examples as disclosed herein, such as the communication of signaling using an updated phase at 540 as described with reference to FIG. 5. In some examples, aspects of the operations of 1315 may be performed by a phase estimation component 845 as described with reference to FIG. 8.

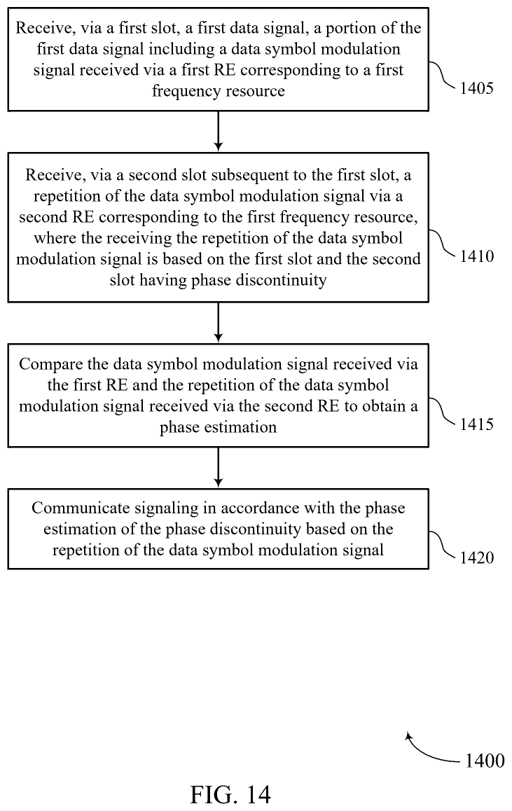

FIG. 14 shows a flowchart illustrating a method 1400 that supports phase discontinuity management with RE repetition in accordance with one or more aspects of the present disclosure. The operations of the method 1400 may be implemented by a second wireless communication device, such as a UE, a network entity, or components of a UE or network entity as described herein. For example, the operations of the method 1400 may be performed by a UE 115 or a network entity 105 as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1405, the method may include receiving, via a first slot, a first data signal. A portion of the first data signal may include a data symbol modulation signal received via a first RE corresponding to a first frequency resource. The operations of 1405 may be performed in accordance with examples as disclosed herein, such as the reception of a first data signal 315-a as described with reference to FIG. 3, the reception of data symbols 425 via the first slot 405-a as described with reference to FIG. 4A, the reception of a first data signal at 510 as described with reference to FIG. 5, or any combination there. In some examples, aspects of the operations of 1405 may be performed by a data reception component 840 as described with reference to FIG. 8.

At 1410, the method may include receiving, via a second slot subsequent to the first slot, a repetition of the data symbol modulation signal via a second RE corresponding to the first frequency resource. The receiving the repetition of the data symbol modulation signal may be based on the first slot and the second slot having phase discontinuity. The operations of 1410 may be performed in accordance with examples as disclosed herein, such as the reception of a repeated data symbol modulation signal 325 via a second data signal 315-b as described with reference to FIG. 3, the reception of a repetition 430-a of a data symbol modulation signal 415-a via the second slot 405-b as described with reference to FIG. 4A, the reception of a second data signal with an RE repetition at 530 as described with reference to FIG. 5, or any combination thereof. In some examples, aspects of the operations of 1410 may be performed by a repetition component 830 as described with reference to FIG. 8.

At 1415, the method may include comparing the data symbol modulation signal received via the first RE and the repetition of the data symbol modulation signal received via the second RE to obtain a phase estimation. The operations of 1415 may be performed in accordance with examples as disclosed herein, such as performance of a phase estimation at 535 as described with reference to FIG. 5. In some examples, aspects of the operations of 1415 may be performed by a phase estimation component 845 as described with reference to FIG. 8.

At 1420, the method may include communicating signaling in accordance with the phase estimation of the phase discontinuity based on the repetition of the data symbol modulation signal. The operations of 1420 may be performed in accordance with examples as disclosed herein, such as the communication of signaling using an updated phase at 540 as described with reference to FIG. 5. In some examples, aspects of the operations of 1420 may be performed by a phase estimation component 845 as described with reference to FIG. 8.

The following provides an overview of aspects of the present disclosure:

Aspect 1: A method for wireless communications, comprising: transmitting, via a first slot, a first data signal, a portion of the first data signal comprising a data symbol modulation signal transmitted via a first RE corresponding to a first frequency resource; transmitting, via a second slot subsequent to the first slot, a repetition of the data symbol modulation signal via a second RE corresponding to the first frequency resource, wherein the transmitting the repetition of the data symbol modulation signal is based at least in part on the first slot and the second slot having phase discontinuity; and communicating signaling in accordance with the phase discontinuity based at least in part on the repetition of the data symbol modulation signal.

Aspect 2: The method of aspect 1, further comprising: communicating an RRC message indicating an RE repetition frequency domain pattern, wherein the transmitting the repetition of the data symbol modulation signal is in accordance with the RE repetition frequency domain pattern.

Aspect 3: The method of either of aspects 1 or 2, further comprising: transmitting a control information message dynamically indicating the repetition of the data symbol modulation signal based at least in part on the first slot and the second slot having the phase discontinuity.

Aspect 4: The method of either of aspects 1 or 2, further comprising: transmitting one or more control information messages dynamically indicating the repetition of the data symbol modulation signal and a time domain resource of the second RE based at least in part on the first slot and the second slot having the phase discontinuity.

Aspect 5: The method of any of aspects 1 through 4, wherein the data symbol modulation signal and the repetition of the data symbol modulation signal are transmitted using a same precoder.

Aspect 6: The method of any of aspects 1 through 5, further comprising: puncturing a second portion of a second data signal associated with the second slot, wherein transmitting the repetition of the data symbol modulation signal comprises: transmitting, via the second slot, the second data signal, the second portion of the second data signal comprising the repetition of the data symbol modulation signal transmitted via the second RE corresponding to the first frequency resource based at least in part on the puncturing.

Aspect 7: The method of aspect 6, wherein: the first RE corresponds to a last symbol of the first data signal transmitted via the first slot preceding a phase discontinuity gap associated with the first slot and the second slot having the phase discontinuity; and the second RE corresponds to a first symbol of the second data signal transmitted via the second slot subsequent to the phase discontinuity gap.

Aspect 8: The method of either of aspects 6 or 7, wherein: the data symbol modulation signal and the repetition of the data symbol modulation signal are transmitted using a first precoder associated with the first data signal; and an unpunctured portion of the second data signal is transmitted using a second precoder associated with the second data signal and different from the first precoder.

Aspect 9: The method of any of aspects 1 through 8, wherein transmitting the repetition of the data symbol modulation signal comprises: transmitting, via the second slot, a plurality of repetitions of respective data symbol modulation signals in accordance with an RE repetition frequency domain pattern indicating a repetition density of REs per set of RBs, the first data signal comprising the respective data symbol modulation signals.

Aspect 10: The method of any of aspects 1 through 9, wherein the repetition of the data symbol modulation signal comprises a first repetition of a first data symbol modulation signal corresponding to a first set of coherent DMRS ports, the method further comprising: transmitting, via the second slot, a second repetition of a second data symbol modulation signal corresponding to a second set of coherent DMRS ports, a second portion of the first data signal comprising the second data symbol modulation signal, wherein the communicating the signaling is in accordance with a first phase discontinuity based at least in part on the first repetition of the first data symbol modulation signal and a second phase discontinuity based at least in part on the second repetition of the second data symbol modulation signal.

Aspect 11: The method of aspect 10, wherein transmitting the first data signal comprises: rate matching the portion of the first data signal comprising the first data symbol modulation signal according to a first spatial layer associated with the first set of coherent DMRS ports; and rate matching the second portion of the first data signal comprising the second data symbol modulation signal according to a second spatial layer associated with the second set of coherent DMRS ports.

Aspect 12: The method of either of aspects 10 or 11, wherein transmitting the first repetition of the first data symbol modulation signal and transmitting the second repetition of the second data symbol modulation signal comprise: transmitting, via the second slot, a first plurality of repetitions of respective first data symbol modulation signals corresponding to the first set of coherent DMRS ports and a second plurality of repetitions of respective second data symbol modulation signals corresponding to the second set of coherent DMRS ports, wherein the transmitting the first plurality of repetitions and the second plurality of repetitions is in accordance with an RE repetition frequency domain pattern indicating a repetition density of REs per set of RBs for both the first plurality of repetitions and the second plurality of repetitions, and the first data signal comprises the respective first data symbol modulation signals and the respective second data symbol modulation signals.

Aspect 13: The method of any of aspects 1 through 12, further comprising: determining, concurrent to the transmitting the first data signal via the first slot, to change a phase between the first slot and the second slot, wherein the transmitting the repetition of the data symbol modulation signal is further based at least in part on the determining.

Aspect 14: The method of any of aspects 1 through 13, wherein the data symbol modulation signal comprises a QAM signal or a QPSK modulation signal.

Aspect 15: A method for wireless communications, comprising: receiving, via a first slot, a first data signal, a portion of the first data signal comprising a data symbol modulation signal received via a first RE corresponding to a first frequency resource; receiving, via a second slot subsequent to the first slot, a repetition of the data symbol modulation signal via a second RE corresponding to the first frequency resource, wherein the receiving the repetition of the data symbol modulation signal is based at least in part on the first slot and the second slot having phase discontinuity; and communicating signaling in accordance with a phase estimation of the phase discontinuity based at least in part on the repetition of the data symbol modulation signal.

Aspect 16: The method of aspect 15, further comprising: comparing the data symbol modulation signal received via the first RE and the repetition of the data symbol modulation signal received via the second RE to obtain the phase estimation.

Aspect 17: The method of either of aspects 15 or 16, further comprising: communicating an RRC message indicating an RE repetition frequency domain pattern, wherein the receiving the repetition of the data symbol modulation signal is in accordance with the RE repetition frequency domain pattern.

Aspect 18: The method of any of aspects 15 through 17, further comprising: receiving a control information message dynamically indicating the repetition of the data symbol modulation signal based at least in part on the first slot and the second slot having the phase discontinuity.

Aspect 19: The method of any of aspects 15 through 17, further comprising: receiving one or more control information messages dynamically indicating the repetition of the data symbol modulation signal and a time domain resource of the second RE based at least in part on the first slot and the second slot having the phase discontinuity.

Aspect 20: The method of any of aspects 15 through 19, wherein receiving the repetition of the data symbol modulation signal comprises: receiving, via the second slot, a second data signal, a second portion of the second data signal punctured with the repetition of the data symbol modulation signal.

Aspect 21: The method of aspect 20, wherein: the first RE corresponds to a last symbol of the first data signal received via the first slot preceding a phase discontinuity gap associated with the phase discontinuity; and the second RE corresponds to a first symbol of the second data signal received via the second slot subsequent to the phase discontinuity gap.

Aspect 22: The method of any of aspects 15 through 21, wherein receiving the repetition of the data symbol modulation signal comprises: receiving, via the second slot, a plurality of repetitions of respective data symbol modulation signals in accordance with an RE repetition frequency domain pattern indicating a repetition density of REs per set of RBs, the first data signal comprising the respective data symbol modulation signals.

Aspect 23: The method of any of aspects 15 through 22, wherein the repetition of the data symbol modulation signal comprises a first repetition of a first data symbol modulation signal corresponding to a first set of coherent DMRS ports, the method further comprising: receiving, via the second slot, a second repetition of a second data symbol modulation signal corresponding to a second set of coherent DMRS ports, a second portion of the first data signal comprising the second data symbol modulation signal, wherein the communicating the signaling is in accordance with a first phase estimation of a first phase discontinuity based at least in part on the first repetition of the first data symbol modulation signal and a second phase estimation of a second phase discontinuity based at least in part on the second repetition of the second data symbol modulation signal.

Aspect 24: The method of aspect 23, wherein receiving the first repetition of the first data symbol modulation signal and receiving the second repetition of the second data symbol modulation signal comprise: receiving, via the second slot, a first plurality of repetitions of respective first data symbol modulation signals corresponding to the first set of coherent DMRS ports and a second plurality of repetitions of respective second data symbol modulation signals corresponding to the second set of coherent DMRS ports, wherein the receiving the first plurality of repetitions and the second plurality of repetitions is in accordance with an RE repetition frequency domain pattern indicating a repetition density of REs per set of RBs for both the first plurality of repetitions and the second plurality of repetitions, and the first data signal comprises the respective first data symbol modulation signals and the respective second data symbol modulation signals.

Aspect 25: The method of any of aspects 15 through 24, wherein the data symbol modulation signal comprises a QAM signal or a QPSK modulation signal.

Aspect 26: An apparatus for wireless communications, comprising: one or more memories storing processor-executable code; and one or more processors coupled with the one or more memories and individually or collectively operable to execute the code to cause the apparatus to perform a method of any of aspects 1 through 14.

Aspect 27: An apparatus for wireless communications, comprising at least one means for performing a method of any of aspects 1 through 14.

Aspect 28: A non-transitory computer-readable medium storing code for wireless communications, the code comprising instructions executable by one or more processors to perform a method of any of aspects 1 through 14.

Aspect 29: An apparatus for wireless communications, comprising: one or more memories storing processor-executable code; and one or more processors coupled with the one or more memories and individually or collectively operable to execute the code to cause the apparatus to perform a method of any of aspects 15 through 25.

Aspect 30: An apparatus for wireless communications, comprising at least one means for performing a method of any of aspects 15 through 25.

Aspect 31: A non-transitory computer-readable medium storing code for wireless communications, the code comprising instructions executable by one or more processors to perform a method of any of aspects 15 through 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
transmit, via a first slot, a first data signal, a portion of the first data signal comprising a data symbol modulation signal transmitted via a first resource element corresponding to a first frequency resource;
transmit, via a second slot subsequent to the first slot, a repetition of the data symbol modulation signal via a second resource element corresponding to the first frequency resource, wherein the transmitting the repetition of the data symbol modulation signal is based at least in part on the first slot and the second slot having phase discontinuity; and
communicate signaling in accordance with the phase discontinuity based at least in part on the repetition of the data symbol modulation signal.

2. The apparatus of claim 1, wherein the one or more processors are individually or collectively further operable to execute the code to cause the apparatus to:
communicate a radio resource control message indicating a resource element repetition frequency domain pattern, wherein the transmitting the repetition of the data symbol modulation signal is in accordance with the resource element repetition frequency domain pattern.

3. The apparatus of claim 1, wherein the one or more processors are individually or collectively further operable to execute the code to cause the apparatus to:
transmit a control information message dynamically indicating the repetition of the data symbol modulation signal based at least in part on the first slot and the second slot having the phase discontinuity.

4. The apparatus of claim 1, wherein the one or more processors are individually or collectively further operable to execute the code to cause the apparatus to:
transmit one or more control information messages dynamically indicating the repetition of the data symbol modulation signal and a time domain resource of the second resource element based at least in part on the first slot and the second slot having the phase discontinuity.

5. The apparatus of claim 1, wherein the data symbol modulation signal and the repetition of the data symbol modulation signal are transmitted using a same precoder.

6. The apparatus of claim 1, wherein the one or more processors are individually or collectively further operable to execute the code to cause the apparatus to:
puncture a second portion of a second data signal associated with the second slot, wherein, to transmit the repetition of the data symbol modulation signal, the one or more processors are individually or collectively operable to execute the code to cause the apparatus to:
transmit, via the second slot, the second data signal, the second portion of the second data signal comprising the repetition of the data symbol modulation signal transmitted via the second resource element corresponding to the first frequency resource based at least in part on the puncturing.

7. The apparatus of claim 6, wherein:
the first resource element corresponds to a last symbol of the first data signal transmitted via the first slot preceding a phase discontinuity gap associated with the first slot and the second slot having the phase discontinuity; and
the second resource element corresponds to a first symbol of the second data signal transmitted via the second slot subsequent to the phase discontinuity gap.

8. The apparatus of claim 6, wherein:
the data symbol modulation signal and the repetition of the data symbol modulation signal are transmitted using a first precoder associated with the first data signal; and
an unpunctured portion of the second data signal is transmitted using a second precoder associated with the second data signal and different from the first precoder.

9. The apparatus of claim 1, wherein, to transmit the repetition of the data symbol modulation signal, the one or more processors are individually or collectively operable to execute the code to cause the apparatus to:
transmit, via the second slot, a plurality of repetitions of respective data symbol modulation signals in accordance with a resource element repetition frequency domain pattern indicating a repetition density of resource elements per set of resource blocks, the first data signal comprising the respective data symbol modulation signals.

10. The apparatus of claim 1, wherein the repetition of the data symbol modulation signal comprises a first repetition of a first data symbol modulation signal corresponding to a first set of coherent demodulation reference signal ports, and the one or more processors are individually or collectively further operable to execute the code to cause the apparatus to:
transmit, via the second slot, a second repetition of a second data symbol modulation signal corresponding to a second set of coherent demodulation reference signal ports, a second portion of the first data signal comprising the second data symbol modulation signal,
wherein the communicating the signaling is in accordance with a first phase discontinuity based at least in part on the first repetition of the first data symbol modulation signal and a second phase discontinuity based at least in part on the second repetition of the second data symbol modulation signal.

11. The apparatus of claim 10, wherein, to transmit the first data signal, the one or more processors are individually or collectively operable to execute the code to cause the apparatus to:
rate match the portion of the first data signal comprising the first data symbol modulation signal according to a first spatial layer associated with the first set of coherent demodulation reference signal ports; and
rate match the second portion of the first data signal comprising the second data symbol modulation signal according to a second spatial layer associated with the second set of coherent demodulation reference signal ports.

12. The apparatus of claim 10, wherein, to transmit the first repetition of the first data symbol modulation signal and to transmit the second repetition of the second data symbol modulation signal, the one or more processors are individually or collectively operable to execute the code to cause the apparatus to:
transmit, via the second slot, a first plurality of repetitions of respective first data symbol modulation signals corresponding to the first set of coherent demodulation reference signal ports and a second plurality of repetitions of respective second data symbol modulation signals corresponding to the second set of coherent demodulation reference signal ports,
wherein the transmitting the first plurality of repetitions and the second plurality of repetitions is in accordance with a resource element repetition frequency domain pattern indicating a repetition density of resource elements per set of resource blocks for both the first plurality of repetitions and the second plurality of repetitions, and
the first data signal comprises the respective first data symbol modulation signals and the respective second data symbol modulation signals.

13. The apparatus of claim 1, wherein the one or more processors are individually or collectively further operable to execute the code to cause the apparatus to:
determine, concurrent to the transmitting the first data signal via the first slot, to change a phase between the first slot and the second slot, wherein the transmitting the repetition of the data symbol modulation signal is further based at least in part on the determining.

14. The apparatus of claim 1, wherein the data symbol modulation signal comprises a quadrature amplitude modulation signal or a quadrature phase shift keying modulation signal.

15. An apparatus, comprising:
one or more memories storing processor-executable code; and
one or more processors coupled with the one or more memories and individually or collectively operable to execute the code to cause the apparatus to:
receive, via a first slot, a first data signal, a portion of the first data signal comprising a data symbol modulation signal received via a first resource element corresponding to a first frequency resource;
receive, via a second slot subsequent to the first slot, a repetition of the data symbol modulation signal via a second resource element corresponding to the first frequency resource, wherein the receiving the repetition of the data symbol modulation signal is based at least in part on the first slot and the second slot having phase discontinuity; and
communicate signaling in accordance with a phase estimation of the phase discontinuity based at least in part on the repetition of the data symbol modulation signal.

16. The apparatus of claim 15, wherein the one or more processors are individually or collectively further operable to execute the code to cause the apparatus to:
compare the data symbol modulation signal received via the first resource element and the repetition of the data symbol modulation signal received via the second resource element to obtain the phase estimation.

17. The apparatus of claim 15, wherein the one or more processors are individually or collectively further operable to execute the code to cause the apparatus to:
communicate a radio resource control message indicating a resource element repetition frequency domain pattern, wherein the receiving the repetition of the data symbol modulation signal is in accordance with the resource element repetition frequency domain pattern.

18. The apparatus of claim 15, wherein the one or more processors are individually or collectively further operable to execute the code to cause the apparatus to:
receive a control information message dynamically indicating the repetition of the data symbol modulation signal based at least in part on the first slot and the second slot having the phase discontinuity.

19. The apparatus of claim 15, wherein the one or more processors are individually or collectively further operable to execute the code to cause the apparatus to:
receive one or more control information messages dynamically indicating the repetition of the data symbol modulation signal and a time domain resource of the second resource element based at least in part on the first slot and the second slot having the phase discontinuity.

20. The apparatus of claim 15, wherein, to receive the repetition of the data symbol modulation signal, the one or more processors are individually or collectively operable to execute the code to cause the apparatus to:
receive, via the second slot, a second data signal, a second portion of the second data signal punctured with the repetition of the data symbol modulation signal.

21. The apparatus of claim 20, wherein:
the first resource element corresponds to a last symbol of the first data signal received via the first slot preceding a phase discontinuity gap associated with the phase discontinuity; and
the second resource element corresponds to a first symbol of the second data signal received via the second slot subsequent to the phase discontinuity gap.

22. The apparatus of claim 15, wherein, to receive the repetition of the data symbol modulation signal, the one or more processors are individually or collectively operable to execute the code to cause the apparatus to:
receive, via the second slot, a plurality of repetitions of respective data symbol modulation signals in accordance with a resource element repetition frequency domain pattern indicating a repetition density of resource elements per set of resource blocks, the first data signal comprising the respective data symbol modulation signals.

23. The apparatus of claim 15, wherein the repetition of the data symbol modulation signal comprises a first repetition of a first data symbol modulation signal corresponding to a first set of coherent demodulation reference signal ports, and the one or more processors are individually or collectively further operable to execute the code to cause the apparatus to:
receive, via the second slot, a second repetition of a second data symbol modulation signal corresponding to a second set of coherent demodulation reference signal ports, a second portion of the first data signal comprising the second data symbol modulation signal,
wherein the communicating the signaling is in accordance with a first phase estimation of a first phase discontinuity based at least in part on the first repetition of the first data symbol modulation signal and a second phase estimation of a second phase discontinuity based at least in part on the second repetition of the second data symbol modulation signal.

24. The apparatus of claim 23, wherein, to receive the first repetition of the first data symbol modulation signal and to receive the second repetition of the second data symbol modulation signal, the one or more processors are individually or collectively operable to execute the code to cause the apparatus to:
receive, via the second slot, a first plurality of repetitions of respective first data symbol modulation signals corresponding to the first set of coherent demodulation reference signal ports and a second plurality of repetitions of respective second data symbol modulation signals corresponding to the second set of coherent demodulation reference signal ports,
wherein the receiving the first plurality of repetitions and the second plurality of repetitions is in accordance with a resource element repetition frequency domain pattern indicating a repetition density of resource elements per set of resource blocks for both the first plurality of repetitions and the second plurality of repetitions, and
the first data signal comprises the respective first data symbol modulation signals and the respective second data symbol modulation signals.

25. The apparatus of claim 15, wherein the data symbol modulation signal comprises a quadrature amplitude modulation signal or a quadrature phase shift keying modulation signal.

26. A method for wireless communications, comprising:
transmitting, via a first slot, a first data signal, a portion of the first data signal comprising a data symbol modulation signal transmitted via a first resource element corresponding to a first frequency resource;
transmitting, via a second slot subsequent to the first slot, a repetition of the data symbol modulation signal via a second resource element corresponding to the first frequency resource, wherein the transmitting the repetition of the data symbol modulation signal is based at least in part on the first slot and the second slot having phase discontinuity; and
communicating signaling in accordance with the phase discontinuity based at least in part on the repetition of the data symbol modulation signal.

27. The method of claim 26, further comprising:
communicating a radio resource control message indicating a resource element repetition frequency domain pattern, wherein the transmitting the repetition of the data symbol modulation signal is in accordance with the resource element repetition frequency domain pattern.

28. The method of claim 26, further comprising:
transmitting a control information message dynamically indicating the repetition of the data symbol modulation signal based at least in part on the first slot and the second slot having the phase discontinuity.

29. The method of claim 26, further comprising:
transmitting one or more control information messages dynamically indicating the repetition of the data symbol modulation signal and a time domain resource of the second resource element based at least in part on the first slot and the second slot having the phase discontinuity.

30. A method for wireless communications, comprising:
receiving, via a first slot, a first data signal, a portion of the first data signal comprising a data symbol modulation signal received via a first resource element corresponding to a first frequency resource;
receiving, via a second slot subsequent to the first slot, a repetition of the data symbol modulation signal via a second resource element corresponding to the first frequency resource, wherein the receiving the repetition of the data symbol modulation signal is based at least in part on the first slot and the second slot having phase discontinuity; and
communicating signaling in accordance with a phase estimation of the phase discontinuity based at least in part on the repetition of the data symbol modulation signal.
